(19) United States
(12) Patent Application Publication
(10) Pub. No.: US 2026/0253600 A1
(43) Pub. Date: Aug. 27, 2026

(54) SYSTEM

(71) Applicant: SoftBank Group Corp., Tokyo (JP)

(72) Inventor: Yuka KOBAYASHI, Tokyo (JP)

(73) Assignee: SoftBank Group Corp., Tokyo (JP)

(21) Appl. No.: 19/542,681

(22) Filed: Feb. 18, 2026

(30) Foreign Application Priority Data
Feb. 21, 2025 (JP) 2025-026977

(51) Int. Cl. G10L 21/10; G06V 40/16; G08B 7/06; G08B 21/02; G09B 21/00; G10L 15/04; G10L 15/16; G10L 15/26; G10L 21/0216; G10L 25/63; H04W 4/029; H04W 4/33; H04W 4/90

(52) U.S. Cl. CPC G10L 21/10; G06V 40/174; G08B 7/06; G08B 21/02; G09B 21/009; G10L 15/04; G10L 15/16; G10L 15/26; G10L 21/0216; G10L 25/63; H04W 4/029; H04W 4/33; H04W 4/90; G10L 2021/02163

(57) ABSTRACT

The system according to the embodiment comprises a reception unit, a recognition unit, and a notification unit. The reception unit receives emergency broadcasts. The recognition unit recognizes audio received by the reception unit in real time and converts it into text. The notification unit notifies the text converted by the recognition unit.

### CROSS-REFERENCE TO RELATED APPLICATION

The present application claims priority to and incorporates by reference the entire contents of Japanese Patent Application No. 2025-026977 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to notify emergency broadcasts to hearing-impaired persons in real time.

### SUMMARY OF THE INVENTION

The system according to the embodiment comprises a reception unit, a recognition unit, and a notification unit. The reception unit receives emergency broadcasts. The recognition unit recognizes audio received by the reception unit in real time and converts it into text. The notification unit notifies the text converted by the recognition unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

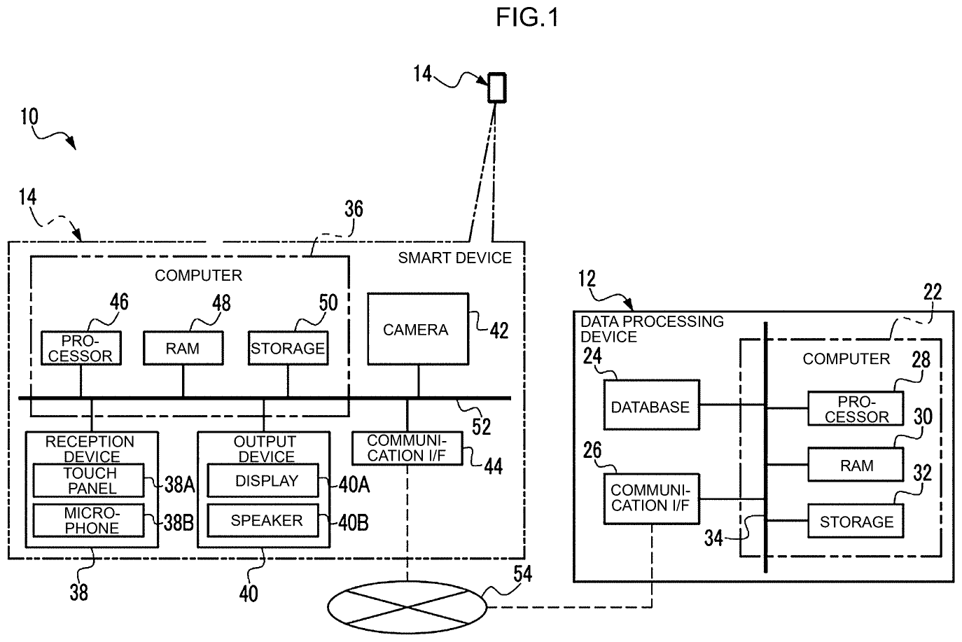

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

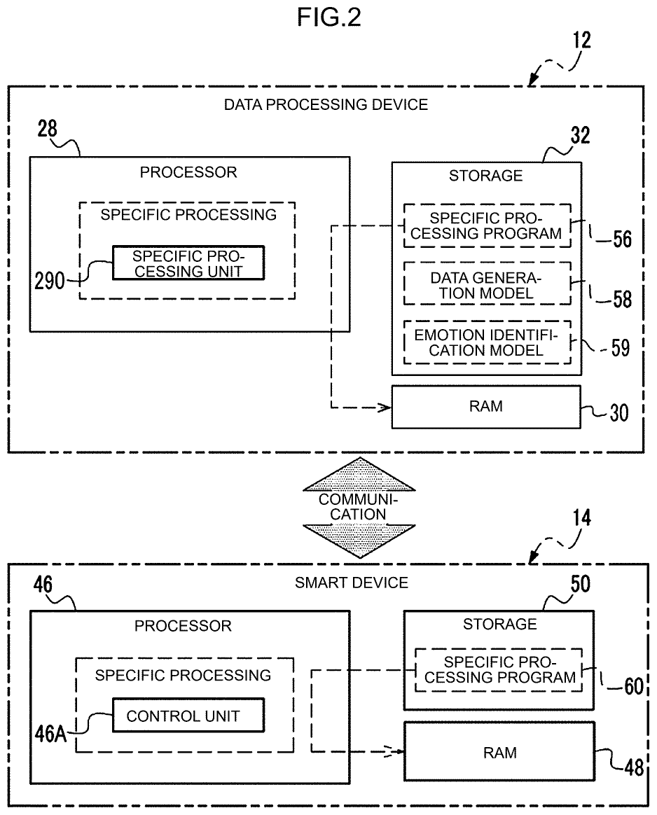

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system in which AI recognizes emergency broadcasts in real time via an application with a single touch and notifies hearing-impaired users. In this system, the user receives emergency broadcasts via the application, and the AI recognizes the received audio in real time and converts it into text. The converted text is then notified to hearing-impaired users. With this system, hearing-impaired users can instantly grasp the content of emergency broadcasts. For example, the user receives an emergency broadcast via the application. At this time, the user launches the application and operates a button to receive the emergency broadcast with a single touch. For instance, in the event of an emergency such as an earthquake or fire, the user only needs to launch the application and press the button to receive the emergency broadcast. Next, the AI recognizes the received audio in real time and converts it into text. The AI uses speech recognition technology to analyze the received audio and convert it into text. For example, if an emergency broadcast such as “An earthquake has occurred. Please evacuate.” is received, the AI analyzes this audio and converts it into the text “An earthquake has occurred. Please evacuate.” The converted text is then notified to hearing-impaired users. Notification methods include displaying the text on a smartphone screen or notifying by vibration. For example, the text is displayed on the smartphone screen and simultaneously notified to the user by vibration. In this way, hearing-impaired users can instantly grasp the content of emergency broadcasts. With this system, hearing-impaired users can grasp the content of emergency broadcasts in real time and respond quickly. For example, in the event of an earthquake, hearing-impaired users can immediately take evacuation actions. Similarly, in the event of a fire, they can evacuate quickly. In this way, the safety of hearing-impaired users can be ensured. Thus, the system can notify hearing-impaired users of the content of emergency broadcasts in real time. Specifically, the system is configured by combining a dedicated application running on mobile devices such as smartphones or tablets and a neural network model for speech recognition implemented on the cloud or within the device (for example, a convolutional neural network, recurrent neural network, or Transformer-based speech recognition model). When the user launches the application and taps the emergency broadcast reception button, the system acquires audio data from the device's microphone input in 16 kHz, 16 bit, monaural PCM format. The acquired audio data is first processed by a preprocessing unit for noise reduction (such as spectral subtraction or Wiener filtering), volume normalization, and frame segmentation (e.g., 25 ms window, 10 ms shift), and then converted into feature vector sequences such as Mel-frequency cepstral coefficients (MFCC) or low-power spectra (e.g., 13-dimensional MFCC+delta+delta-delta=39 dimensions). These feature vector sequences (e.g., 300 frames×39 dimensions) are supplied to the input layer of the speech recognition model. The speech recognition model, for example, has an encoder-decoder structure, where the encoder maps the time-series feature vectors to a high-dimensional latent space, and the decoder sequentially generates character sequences (e.g., “An earthquake has occurred. Please evacuate.”) using CTC (Connectionist Temporal Classification) or Attention mechanisms. The output is obtained as a UTF-8 encoded text string, and confidence scores (e.g., 0.98) and per-word confidence distributions are also output simultaneously. As a specific example, when the input audio is “JISHIN GA HASSEI SHIMASHITA. HINAN SHITE KUDASAI.”, the output text is “An earthquake has occurred. Please evacuate.” with a confidence of 0.97. In another example, for “KASAI GA HASSEI SHIMASHITA. HINAN SHITE KUDASAI.”, the output text is “A fire has occurred. Please evacuate.” with a confidence of 0.95. These text outputs are passed to the notification unit, which uses the device's screen display API to display the text in a large font at the center and simultaneously calls the device's vibration control API to generate continuous vibration for 1.5 seconds. The notification unit can also optimize the notification method (display color, font size, vibration pattern, etc.) by referring to the user's device settings, past notification history, and emotional state (e.g., stress level estimated from facial images or voice). The AI-based speech recognition process, unlike conventional human listening and transcription, performs pattern matching, sequence labeling, and probabilistic inference in a high-dimensional feature space on high-speed parallel computing clusters, enabling both real-time performance and high accuracy. Furthermore, the AI model uses pre-trained weights and can adapt to emergency broadcast-specific vocabulary and intonation through transfer learning and online learning. As a technical effect, this system can convert the content of emergency broadcasts into text with high accuracy within a few seconds and immediately notify hearing-impaired users, thereby enabling faster initial response and improved safety during disasters compared to conventional manual information transmission. In addition, diversification of notification methods (screen display, vibration, speech synthesis, etc.) and optimization according to user status enable optimal information transmission for each user. Specific application fields include emergency broadcasts during natural disasters such as earthquakes, fires, tsunamis, and typhoons; in-house broadcasts at railways, airports, and commercial facilities; evacuation instruction broadcasts at schools and hospitals; and all situations where real-time information transmission to diverse users including hearing-impaired and elderly people is required.

The system according to the embodiment comprises a reception unit, a recognition unit, and a notification unit. The reception unit receives emergency broadcasts. For example, the user receives emergency broadcasts via the application. At this time, the user launches the application and operates a button to receive the emergency broadcast with a single touch. For instance, in the event of an emergency such as an earthquake or fire, the user only needs to launch the application and press the button to receive the emergency broadcast. The recognition unit uses AI to recognize the received audio in real time and convert it into text. For example, if an emergency broadcast such as “An earthquake has occurred. Please evacuate.” is received, the recognition unit analyzes this audio and converts it into the text “An earthquake has occurred. Please evacuate.” The notification unit notifies hearing-impaired users of the converted text. Notification methods include displaying the text on a smartphone screen or notifying by vibration. For example, the text is displayed on the smartphone screen and simultaneously notified to the user by vibration. Thus, the system can notify hearing-impaired users of the content of emergency broadcasts in real time. Some or all of the above-described processing in the reception unit may be performed using AI or without using AI. For example, the reception unit can automate the operation of pressing the button to receive emergency broadcasts using AI. Some or all of the above-described processing in the recognition unit may be performed using generative AI or without using generative AI. For example, the recognition unit can input the received audio to generative AI and convert it into text using generative AI. Some or all of the above-described processing in the notification unit may be performed using AI or without using AI. For example, the notification unit can notify the converted text in an optimal way using AI. Thus, the system can notify hearing-impaired users of the content of emergency broadcasts in real time. Specifically, the system is configured by combining a dedicated application running on mobile devices such as smartphones or tablets and a neural network model for speech recognition implemented on the cloud or within the device. When the user launches the application and taps the emergency broadcast reception button, the system acquires audio data from the device's microphone input (e.g., 16 kHz, 16 bit, monaural PCM). After acquiring the audio data, the reception unit executes noise reduction (such as spectral subtraction or Wiener filtering), volume normalization, and frame segmentation (e.g., 25 ms window, 10 ms shift) by a preprocessing unit, and converts the data into feature vector sequences such as Mel-frequency cepstral coefficients (MFCC) or low-power spectra (e.g., 13-dimensional MFCC+delta+delta-delta=39 dimensions). These feature vector sequences (e.g., 300 frames×39 dimensions) are supplied to the input layer of the recognition unit's speech recognition model. The recognition unit uses, for example, a Transformer-based speech recognition model with an encoder-decoder structure, where the encoder maps the time-series feature vectors to a high-dimensional latent space, and the decoder sequentially generates character sequences (e.g., “An earthquake has occurred. Please evacuate.”) using CTC or Attention mechanisms. Examples of AI input include MFCC sequences of 300 frames×39 dimensions or noise-reduced audio waveform tensors. Examples of AI output include UTF-8 encoded text strings (e.g., “A fire has occurred. Please evacuate.”), confidence scores (e.g., 0.95), and per-word confidence distributions (e.g., 0.90-0.99 for each word). As subsequent processing, the notification unit displays the output text in a large font at the center of the device using the screen display API and calls the vibration control API to generate continuous vibration for 1.5 seconds. The notification unit can also optimize the notification method (display color, font size, vibration pattern, etc.) by referring to the user's device settings, past notification history, and emotional state (e.g., stress level estimated from facial images or voice). The AI-based speech recognition process, unlike conventional human listening and transcription, performs pattern matching, sequence labeling, and probabilistic inference in a high-dimensional feature space on high-speed parallel computing clusters, enabling both real-time performance and high accuracy. Furthermore, the AI model uses pre-trained weights and can adapt to emergency broadcast-specific vocabulary and intonation through transfer learning and online learning. As a technical effect, this system can convert the content of emergency broadcasts into text with high accuracy within a few seconds and immediately notify hearing-impaired users, thereby enabling faster initial response and improved safety during disasters compared to conventional manual information transmission. In addition, diversification of notification methods (screen display, vibration, speech synthesis, etc.) and optimization according to user status enable optimal information transmission for each user. Specific application fields include emergency broadcasts during natural disasters such as earthquakes, fires, tsunamis, and typhoons; in-house broadcasts at railways, airports, and commercial facilities; evacuation instruction broadcasts at schools and hospitals; and all situations where real-time information transmission to diverse users including hearing-impaired and elderly people is required.

The notification unit includes a method of displaying text on a smartphone screen. For example, the content of the emergency broadcast is displayed as text on the smartphone screen. For instance, the text “An earthquake has occurred. Please evacuate.” is displayed. The text displayed on the smartphone screen can have its font size and display position adjusted. For example, the font size can be increased to improve visibility. Additionally, the display position can be adjusted so that important information stands out. Furthermore, a scroll function can be used to display long texts. For example, if the content of the emergency broadcast is long, all content can be displayed by scrolling. By displaying text on the smartphone screen, the content of emergency broadcasts can be notified to hearing-impaired users. Specifically, the notification unit utilizes the device's screen display API to display text in various layout patterns, such as center alignment or top-fixed placement. The notification unit can automatically adjust font size (e.g., 24 pt-72 pt), font type (e.g., Gothic, Mincho), and contrast ratio of text and background color (e.g., black text on white background, blue text on yellow background) according to the user's device settings and visual characteristics (e.g., color vision deficiency, low vision). If the text exceeds the screen size, the notification unit has an automatic scroll function, allowing the user to select between manual swipe or automatic vertical scrolling. Furthermore, the notification unit can add emphasis (e.g., bold, underline, color) or icons (e.g., earthquake mark, fire mark) to the text according to the importance or category (e.g., earthquake, fire, tsunami) of the emergency broadcast. As an AI-based optimization function, the notification unit learns from the user's past viewing history and reactions during notifications (e.g., number of screen taps, scroll speed) and automatically selects the most visible and least stressful display method. For example, users who have preferred large fonts and high-contrast colors in the past will continue to be prioritized for similar displays. As a technical effect, optimization of screen display by the notification unit greatly improves visibility and readability for each user compared to conventional uniform text display, contributing to immediate understanding of emergency information and prevention of misinterpretation. Specific application fields include emergency broadcast notifications for hearing-impaired and elderly users, assistance for in-house broadcasts in public facilities and transportation, and multilingual display for foreign language speakers.

The notification unit includes a method of notifying by vibration. Vibration can be used to notify in patterns such as continuous or intermittent vibration. For example, if the content of the emergency broadcast is important, notification can be made by continuous vibration. If the content is relatively less important, notification can be made by intermittent vibration. Furthermore, the intensity of the vibration can also be adjusted. For example, notification with strong vibration can convey urgency to the user. By notifying via vibration, the content of emergency broadcasts can be immediately communicated to hearing-impaired users. Specifically, the notification unit utilizes the device's vibration control API to finely control vibration patterns (e.g., continuous 1.5 seconds, intermittent 0.5 seconds×3 times, Morse code style), vibration intensity (e.g., weak, medium, strong), and the number and interval of vibrations. The notification unit automatically selects the optimal vibration pattern according to the category (e.g., earthquake, fire, tsunami) and importance score (e.g., 0.9 or higher for continuous strong vibration, 0.7-0.9 for intermittent medium vibration) of the emergency broadcast. As an AI-based optimization function, the notification unit learns from the user's past reaction history (e.g., whether the device was operated after vibration notification, time until notification was dismissed) and emotional state (e.g., avoiding strong vibration if stress level is high) to determine the optimal vibration pattern and intensity for each user. For example, if a user has a history of being startled by strong vibration, medium intermittent vibration will be prioritized in the future. The notification unit can also switch notification methods considering device battery level and hardware constraints (e.g., only short vibrations allowed on small devices such as smartwatches). As a technical effect, optimization of vibration control by the notification unit greatly improves the certainty and immediacy of emergency information transmission according to the user's situation and device characteristics compared to conventional uniform vibration notifications. Specific application fields include emergency broadcast notifications for hearing-impaired users or users in noisy environments, non-visual notifications on smartwatches and wearable devices, and silent notifications in public facilities and transportation.

The recognition unit analyzes received audio using speech recognition technology and converts it into text. Speech recognition technology may use, for example, deep learning or HMM (Hidden Markov Model). For instance, using deep learning enables highly accurate speech recognition. Using HMM allows recognition that considers temporal changes in audio. Thus, by using speech recognition technology, emergency broadcast audio can be accurately converted into text. Specifically, the recognition unit receives audio data (e.g., 16 kHz, 16 bit, monaural PCM) as input, executes noise reduction, volume normalization, and frame segmentation in the preprocessing unit, and extracts feature vectors such as Mel-frequency cepstral coefficients (MFCC) or low-power spectra (e.g., 13-dimensional MFCC+delta+delta-delta=39 dimensions). The recognition unit inputs these feature vector sequences (e.g., 300 frames×39 dimensions) into a convolutional neural network (CNN), recurrent neural network (RNN), or Transformer-based speech recognition model. Examples of AI input include noise-reduced MFCC sequences or audio spectrogram images. Examples of AI output include UTF-8 encoded text strings (e.g., “An earthquake has occurred. Please evacuate.”), confidence scores (e.g., 0.98), and per-word confidence distributions (e.g., 0.90-0.99 for each word). The recognition unit uses CTC (Connectionist Temporal Classification) or Attention mechanisms within the model to optimize alignment between audio and character sequences and reduce misrecognition. Furthermore, the recognition unit can utilize transfer learning and online learning to adapt to emergency broadcast-specific vocabulary and intonation. As a technical effect, the introduction of speech recognition technology by the recognition unit achieves real-time performance, high accuracy, and reduced misrecognition compared to conventional human listening and transcription, greatly improving the reliability and immediacy of emergency information transmission. Specific application fields include emergency broadcasts during disasters, automatic text conversion of in-house broadcasts, and translation assistance for foreign language broadcasts.

The recognition unit recognizes audio in real time and converts it into text. To recognize audio in real time, for example, it is necessary to convert audio into text with a delay of only a few seconds. For instance, by converting emergency broadcasts into text within a few seconds of reception, real-time notification becomes possible. Thus, by recognizing audio in real time, the content of emergency broadcasts can be instantly converted into text. Specifically, the recognition unit processes audio data sequentially in frame units (e.g., 25 ms window, 10 ms shift), extracts feature vectors for each frame, and inputs them into the model. The recognition unit uses a streaming-compatible speech recognition model (e.g., streaming Transformer, bidirectional RNN) to generate text output sequentially as audio input arrives. Examples of AI input include continuously arriving audio frame sequences or real-time updated MFCC vector sequences. Examples of AI output include partial text strings (e.g., “An earthquake has occur . . . ”→“An earthquake has occurred.”), and sequentially updated confidence scores (e.g., 0.85→0.92→0.98). When the output text exceeds a certain confidence threshold (e.g., 0.95), the recognition unit immediately transfers it to the notification unit, which instantly executes screen display or vibration notification. The recognition unit utilizes lightweight neural network structures and quantization/distillation techniques to minimize delay within the model and achieve high-speed inference on the device. As a technical effect, real-time speech recognition by the recognition unit enables immediate text conversion and notification of emergency broadcasts compared to conventional batch processing speech recognition, greatly contributing to initial response and safety during disasters. Specific application fields include real-time subtitle generation for emergency broadcasts, instant text notification of live in-house broadcasts, and simultaneous information transmission to remote users.

The reception unit includes a method of estimating a user's emotion and adjusting the timing of receiving emergency broadcasts based on the estimated emotion. For example, if the user is feeling stressed, the reception unit delays the reception of emergency broadcasts so that the user receives them at a calmer time. If the user is relaxed, emergency broadcasts are received immediately to enable prompt response. Furthermore, if the user is in a hurry, emergency broadcasts are preferentially received and important information is notified instantly. Thus, by adjusting the timing of receiving emergency broadcasts according to the user's emotion, notifications can be made at more appropriate times. Emotion estimation is realized using, for example, an emotion engine or generative AI with emotion estimation functions. Generative AI may include text generation AI (e.g., LLM) or multimodal generative AI, but is not limited to these examples. Specifically, the reception unit acquires multimodal data such as the user's facial images, audio, text input, and heart rate, and inputs them into a neural network for emotion estimation (e.g., multimodal Transformer, convolutional+RNN hybrid). Examples of AI input include facial images (224×224 pixel RGB), audio waveforms (3 seconds, 16 kHz), text (e.g., “I'm busy now”), and heart rate time series (60 seconds, 1 Hz sampling). Examples of AI output include emotion labels (e.g., “stress”, “relaxation”, “tension”), emotion intensity scores (e.g., stress 0.85, relaxation 0.10), and estimation confidence (e.g., 0.92). The reception unit controls the timing of receiving emergency broadcasts based on the emotion estimation results. For example, if the stress level is high, reception is delayed by 5 minutes; if relaxed, reception is immediate; if in a hurry, reception is prioritized. The reception unit also refers to the user's past emotion history and reaction history to emergency broadcasts to determine the optimal timing through learning. As a technical effect, emotion estimation and timing control by the reception unit reduce the user's psychological burden and maximize information receptivity and responsiveness compared to conventional uniform information delivery. Specific application fields include medical and educational settings where stress management is important, panic prevention during disasters, and individually optimized information delivery services.

The reception unit analyzes a user's past emergency broadcast reception history and selects an appropriate reception method. For example, based on the types of emergency broadcasts frequently received by the user in the past, the reception unit selects broadcasts to be preferentially received. The reception unit also analyzes the time periods when the user received emergency broadcasts in the past and proposes optimal reception timing. Furthermore, by analyzing the user's reactions to specific emergency broadcasts from past reception history, the reception unit selects the optimal notification method. Thus, by analyzing past reception history, the optimal reception method can be selected. Specifically, the reception unit maintains an emergency broadcast reception history database for each user (e.g., structured data including time, broadcast category, reception device, notification method, user reaction log), and inputs these history data as time-series vectors (e.g., one year of reception events×10 attributes per event) into an AI model. Examples of AI input include reception history vectors for the past 30 days (e.g., 30×10 dimensions, each row representing reception time, broadcast type, notification method, user reaction, etc.), frequency distribution of specific categories (e.g., earthquake, fire), and user operation logs after notifications (e.g., number of screen taps within 30 seconds after notification, time until notification dismissal). The AI inputs these history data into a convolutional neural network, a recurrent neural network specialized for time-series processing, or a Transformer-based time-series analysis model to extract reception tendencies and reaction patterns for each user. Examples of AI output include labels for emergency broadcast categories to be prioritized (e.g., “earthquake” priority 0.95, “fire” priority 0.85), optimal reception timing (e.g., weekdays 18:00-22: 00 optimal), and recommended notification methods (e.g., vibration+screen display, font size 36 pt). The reception unit automatically prioritizes and selects notification methods for emergency broadcasts at the time of reception based on AI output. For example, for users who have shown poor reactions to nighttime notifications in the past, notifications are made by vibration only at night and screen display is repeated in the morning for optimization. The reception unit continuously learns from the user's reception and reaction history and updates model parameters online to flexibly adapt to changes in the user's lifestyle and preferences. As a technical effect, history analysis and reception method optimization by the reception unit maximize information receptivity and responsiveness for each user compared to conventional uniform information delivery, greatly improving the efficiency of emergency broadcast transmission and user satisfaction. Specific application fields include emergency broadcast notifications for individual homes and apartment complexes, individualized optimization of in-house broadcasts in organizations such as companies and schools, and personalized information delivery services according to user attributes.

The reception unit performs filtering based on the user's current location information and situation when receiving an emergency broadcast. For example, if the user is in a specific region, only emergency broadcasts relevant to that region are received. If the user is moving, emergency broadcasts relevant to the destination region are preferentially received. Furthermore, if the user is inside a specific building, emergency broadcasts relevant to that building are received. Thus, by performing filtering based on current location information and situation, highly relevant emergency broadcasts can be received. Specifically, the reception unit acquires location information (e.g., vector data including latitude, longitude, altitude, building ID, floor number) in real time from the device's GPS sensor, Wi-Fi/Bluetooth beacons, indoor positioning systems, etc., and matches it with emergency broadcast metadata (e.g., target region code, building ID, source information). Examples of AI input include current latitude and longitude vectors (e.g., 35.6895, 139.6917), building ID “B123”, movement speed (e.g., 1.2 m/s), and movement trajectory for the past 30 minutes (e.g., 30×2-dimensional coordinate sequence). The AI combines these location and situation data with the target range information of emergency broadcasts and outputs geographic relevance scores (e.g., 0.98) and priority reception flags (e.g., reception permission label). Examples of AI output include “current location is within earthquake warning area: reception priority 1.0”, “destination is within fire warning area: reception priority 0.9”, “building ID matches: reception required”. The reception unit distributes only highly relevant emergency broadcasts to the device based on AI output and filters out unnecessary broadcasts. Furthermore, the reception unit can estimate user movement predictions (e.g., commuting routes, movement tendencies) using time-series AI models and prepare to receive emergency broadcasts for the destination in advance. As a technical effect, location information and situation-based filtering by the reception unit enables rapid and reliable transmission of only truly necessary emergency information to users compared to conventional uniform distribution, preventing information overload and confusion due to misdelivery. Specific application fields include area-limited emergency broadcasts in urban areas and large facilities, personalized alerts for users in transit, and indoor-outdoor integrated disaster information delivery.

The reception unit includes a method of estimating a user's emotion and determining the priority of emergency broadcasts to be received based on the estimated emotion. For example, if the user is tense, emergency broadcasts with high importance are preferentially received. If the user is relaxed, even emergency broadcasts with low importance are received. Furthermore, if the user is in a hurry, only the most important emergency broadcasts are received. Thus, by determining the priority of emergency broadcasts according to the user's emotion, important information can be preferentially notified. Emotion estimation is realized using, for example, an emotion engine or generative AI with emotion estimation functions. Generative AI may include text generation AI (e.g., LLM) or multimodal generative AI, but is not limited to these examples. Specifically, the reception unit acquires multimodal data such as the user's facial images (e.g., 224×224 pixel RGB), audio waveforms (e.g., 3 seconds, 16 kHz), text input (e.g., “I'm busy now”), and heart rate time series (e.g., 60 seconds, 1 Hz sampling), and inputs them into a neural network for emotion estimation (e.g., multimodal Transformer, convolutional+RNN hybrid). Examples of AI input include combinations of facial images, audio, text, and biometric signals, or single-modal data. The AI outputs emotion labels (e.g., “tension”, “relaxation”, “in a hurry”), emotion intensity scores (e.g., tension 0.85, relaxation 0.10), and estimation confidence (e.g., 0.92). The reception unit determines the priority of emergency broadcasts based on AI output. For example, if the tension level is high, only broadcasts with importance scores of 0.9 or higher are received; if relaxed, broadcasts with scores of 0.5 or higher are also received; if in a hurry, only the most important broadcasts are received, using threshold control. The reception unit also refers to the user's past emotion history and reaction history to emergency broadcasts and optimizes the priority determination algorithm through online learning. As a technical effect, emotion estimation and priority control by the reception unit reduce the user's psychological burden and maximize information receptivity and responsiveness compared to conventional uniform information delivery. Specific application fields include medical and educational settings where stress management is important, panic prevention during disasters, and individually optimized information delivery services.

The reception unit preferentially receives highly relevant broadcasts based on the user's geographic location information when receiving emergency broadcasts. For example, if the user is in a specific region, emergency broadcasts relevant to that region are preferentially received. If the user is moving, emergency broadcasts relevant to the destination region are preferentially received. Furthermore, if the user is inside a specific building, emergency broadcasts relevant to that building are preferentially received. Thus, by considering geographic location information, highly relevant emergency broadcasts can be preferentially received. Specifically, the reception unit acquires location information (e.g., vector data including latitude, longitude, altitude, building ID, floor number) in real time from the device's GPS sensor, Wi-Fi/Bluetooth beacons, indoor positioning systems, etc., and matches it with emergency broadcast metadata (e.g., target region code, building ID, source information). Examples of AI input include current latitude and longitude vectors (e.g., 35.6895, 139.6917), building ID “B123”, movement speed (e.g., 1.2 m/s), and movement trajectory for the past 30 minutes (e.g., 30×2-dimensional coordinate sequence). The AI combines these location and situation data with the target range information of emergency broadcasts and outputs geographic relevance scores (e.g., 0.98) and priority reception flags (e.g., reception permission label). Examples of AI output include “current location is within earthquake warning area: reception priority 1.0”, “destination is within fire warning area: reception priority 0.9”, “building ID matches: reception required”. The reception unit distributes only highly relevant emergency broadcasts to the device based on AI output and filters out unnecessary broadcasts. Furthermore, the reception unit can estimate user movement predictions (e.g., commuting routes, movement tendencies) using time-series AI models and prepare to receive emergency broadcasts for the destination in advance. As a technical effect, location information and situation-based filtering by the reception unit enables rapid and reliable transmission of only truly necessary emergency information to users compared to conventional uniform distribution, preventing information overload and confusion due to misdelivery. Specific application fields include area-limited emergency broadcasts in urban areas and large facilities, personalized alerts for users in transit, and indoor-outdoor integrated disaster information delivery.

The reception unit analyzes a user's social media activity when receiving emergency broadcasts and receives relevant broadcasts. For example, if the user posts information about a specific region on social media, emergency broadcasts relevant to that region are received. If the user participates in a specific event on social media, emergency broadcasts relevant to that event are received. Furthermore, if the user uses specific hashtags on social media, emergency broadcasts relevant to those hashtags are received. Thus, by analyzing social media activity, relevant emergency broadcasts can be received. Specifically, the reception unit acquires the user's public social media post data (e.g., post text, location tags, event participation history, hashtag list) via API and inputs them into a natural language processing AI model (e.g., Transformer-based text classification model or multimodal model). Examples of AI input include the most recent 100 post texts (e.g., “#Shibuya #FireworksFestival”, “Today at Shinjuku event”), location information for each post (e.g., latitude and longitude), and hashtag lists (e.g., #earthquake #evacuation #typhoon). The AI outputs interest scores for each region, event, or category (e.g., Shibuya 0.92, Shinjuku 0.85, earthquake 0.95, typhoon 0.80) and relevance labels (e.g., recommend receiving earthquake-related broadcasts). Examples of AI output include “User has high interest in Shibuya events: prioritize receiving Shibuya-related emergency broadcasts”, “High frequency of #earthquake tag: must receive earthquake warnings”. The reception unit preferentially receives and notifies only emergency broadcasts related to the user's interests and actions based on AI output. Furthermore, the reception unit continuously learns from changes in the user's social media activity and updates model parameters online to flexibly respond to changes in areas of interest. As a technical effect, social media analysis and broadcast selection by the reception unit enable information transmission tailored to the user's actual actions and interests compared to conventional uniform distribution, greatly improving the usefulness and receptivity of information. Specific application fields include limited alerts at event venues and tourist spots, SNS-linked disaster information delivery, and personalized alert services according to user attributes.

The recognition unit includes a method of estimating a user's emotion and adjusting the accuracy of speech recognition based on the estimated emotion. For example, if the user is tense, the accuracy of speech recognition is increased to prevent misrecognition. If the user is relaxed, the accuracy of speech recognition is maintained as usual. Furthermore, if the user is in a hurry, the speed of speech recognition is prioritized for rapid text conversion. Thus, by adjusting the accuracy of speech recognition according to the user's emotion, misrecognition can be prevented. Emotion estimation is realized using, for example, an emotion engine or generative AI with emotion estimation functions. Generative AI may include text generation AI (e.g., LLM) or multimodal generative AI, but is not limited to these examples. Specifically, the recognition unit acquires multimodal data such as the user's facial images (224×224 pixel RGB), audio waveforms (3 seconds, 16 kHz), text input (e.g., “I'm tense now”), and heart rate time series (60 seconds, 1 Hz sampling), and inputs them into a neural network for emotion estimation (e.g., multimodal Transformer or convolutional+RNN hybrid model). Examples of AI input include combinations of facial images, audio, text, and biometric signals, or single-modal data (e.g., audio only, facial image only). The AI outputs emotion labels (e.g., “tension”, “relaxation”, “in a hurry”), emotion intensity scores (e.g., tension 0.85, relaxation 0.10), and estimation confidence (e.g., 0.92). The recognition unit dynamically adjusts the operating parameters of the speech recognition model based on AI output. For example, if the tension level is high, the beam search width of the speech recognition model is expanded, and the text with the highest confidence is selected from multiple candidates. If relaxed, inference is performed with normal parameters; if in a hurry, the decoder layer of the model is simplified and inference speed is prioritized. Examples of speech recognition AI input include noise-reduced MFCC sequences (e.g., 300 frames×39 dimensions), audio spectrogram images (e.g., 128×300 pixels). Examples of speech recognition AI output include UTF-8 encoded text strings (e.g., “An earthquake has occurred. Please evacuate.”), confidence scores (e.g., 0.98), and per-word confidence distributions (e.g., 0.90-0.99 for each word). As subsequent processing, when the output text exceeds a certain confidence threshold (e.g., 0.95), the recognition unit immediately transfers it to the notification unit, which executes screen display or vibration notification. The recognition unit uses Attention mechanisms or CTC (Connectionist Temporal Classification) within the model to optimize alignment between audio and character sequences and reduce misrecognition. Furthermore, the recognition unit can utilize transfer learning and online learning to adapt to emergency broadcast-specific vocabulary and intonation. As a technical effect, emotion estimation and speech recognition accuracy control by the recognition unit enable optimal recognition accuracy and speed according to the user's psychological state and situation compared to conventional uniform speech recognition, making it possible to reduce misrecognition and achieve real-time performance. Specific application fields include emergency broadcasts during disasters, information transmission with stress management in medical and educational settings, and personalized speech recognition services according to user status.

The recognition unit adjusts the level of detail of recognition based on the importance of the emergency broadcast during speech recognition. For example, in the case of highly important emergency broadcasts, detailed speech recognition is performed to convert the audio into accurate text. For emergency broadcasts of low importance, normal speech recognition is performed. For emergency broadcasts of moderate importance, speech recognition is performed with an appropriate level of detail. Thus, by adjusting the level of detail of recognition based on the importance of the emergency broadcast, accurate text conversion can be achieved. Specifically, the recognition unit acquires emergency broadcast metadata (e.g., importance score 0.0-1.0, category label, source information) at the time of reception and dynamically changes the inference parameters of the speech recognition model according to the importance score. Examples of AI input include audio feature vector sequences (e.g., 300 frames×39 dimensions of MFCC), importance score of the emergency broadcast (e.g., 0.95), and broadcast category (e.g., earthquake, fire, typhoon). If the importance is high, the recognition unit expands the beam search width of the speech recognition model and selects the text with the highest confidence from multiple candidates. Furthermore, post-processing such as noise reduction, spell check, and grammar correction is also enhanced. If the importance is moderate, standard parameters are used for inference; if low, the decoder layer of the model is simplified and inference speed is prioritized. Examples of AI output include UTF-8 encoded text strings (e.g., “A fire has occurred. Please evacuate.”), confidence scores (e.g., 0.95), and per-word confidence distributions (e.g., 0.90-0.99 for each word). As subsequent processing, when the output text exceeds a certain confidence threshold (e.g., 0.95), the recognition unit immediately transfers it to the notification unit, which executes screen display or vibration notification. The recognition unit uses Attention mechanisms or CTC (Connectionist Temporal Classification) within the model to optimize alignment between audio and character sequences and reduce misrecognition. Furthermore, the recognition unit can utilize transfer learning and online learning to adapt to emergency broadcast-specific vocabulary and intonation. As a technical effect, importance-based control of recognition detail by the recognition unit enables both optimal resource allocation and improved recognition accuracy compared to conventional uniform speech recognition, preventing misrecognition of important information and ensuring real-time performance. Specific application fields include emergency broadcasts during disasters, transmission of important information in medical and educational settings, and personalized speech recognition services according to user status.

The recognition unit applies different recognition algorithms according to the category of the emergency broadcast during speech recognition. For example, in the case of emergency broadcasts related to earthquakes, an algorithm that recognizes earthquake-related technical terms is applied. For emergency broadcasts related to fires, an algorithm that recognizes fire-related technical terms is applied. For emergency broadcasts related to typhoons, an algorithm that recognizes typhoon-related technical terms is applied. Thus, by applying recognition algorithms according to the category, technical terms can be accurately recognized. Specifically, the recognition unit acquires category information of the emergency broadcast (e.g., labels such as earthquake, fire, typhoon) at the time of reception and automatically selects a speech recognition model or vocabulary extension dictionary optimized for each category. Examples of AI input include audio feature vector sequences (e.g., 300 frames×39 dimensions of MFCC) and category labels (e.g., “earthquake”). For the earthquake category, a model enhanced with earthquake-related vocabulary (e.g., “seismic intensity”, “aftershock”, “tsunami”) is applied; for the fire category, a model enhanced with fire-related vocabulary (e.g., “spread”, “extinguish”, “evacuate”) is applied; for the typhoon category, a model enhanced with typhoon-related vocabulary (e.g., “storm”, “high tide”, “track”) is applied. Examples of AI output include UTF-8 encoded text strings (e.g., “An earthquake has occurred. Please evacuate.”), confidence scores (e.g., 0.98), and per-word confidence distributions (e.g., 0.90-0.99 for each word). As subsequent processing, when the output text exceeds a certain confidence threshold (e.g., 0.95), the recognition unit immediately transfers it to the notification unit, which executes screen display or vibration notification. The recognition unit applies different model parameters and Attention mechanism weights for each category to reduce misrecognition of technical terms. Furthermore, the recognition unit can flexibly respond to changes in broadcast content by adding vocabulary and online learning for each category. As a technical effect, application of category-adaptive recognition algorithms by the recognition unit greatly improves the recognition accuracy of technical terms and reduces misrecognition compared to conventional general-purpose speech recognition, significantly enhancing the reliability of emergency information transmission. Specific application fields include emergency broadcasts during disasters, transmission of information containing technical terms in medical and disaster prevention fields, and category-specific speech recognition services in industrial settings.

The recognition unit includes a method of estimating a user's emotion and adjusting the speed of speech recognition based on the estimated emotion. For example, if the user is tense, the speed of speech recognition is slowed down to prioritize accuracy. If the user is relaxed, speech recognition is performed at normal speed. Furthermore, if the user is in a hurry, the speed of speech recognition is increased for rapid text conversion. Thus, by adjusting the speed of speech recognition according to the user's emotion, text can be converted quickly and accurately. Emotion estimation is realized using, for example, an emotion engine or generative AI with emotion estimation functions. Generative AI may include text generation AI (e.g., LLM) or multimodal generative AI, but is not limited to these examples. Specifically, the recognition unit acquires multimodal data such as the user's facial images (224×224 pixel RGB), audio waveforms (3 seconds, 16 kHz), text input (e.g., “I'm in a hurry now”), and heart rate time series (60 seconds, 1 Hz sampling), and inputs them into a neural network for emotion estimation (e.g., multimodal Transformer or convolutional+RNN hybrid model). Examples of AI input include combinations of facial images, audio, text, and biometric signals, or single-modal data. The AI outputs emotion labels (e.g., “tension”, “relaxation”, “in a hurry”), emotion intensity scores (e.g., in a hurry 0.90), and estimation confidence (e.g., 0.93). The recognition unit controls the inference speed of the speech recognition model based on AI output. For example, if the tension level is high, the decoder layer of the model is deepened, sequential rechecking and multiple candidate generation are performed, and recognition accuracy is prioritized. If relaxed, inference is performed at standard speed; if in a hurry, model parameters are simplified and inference speed is maximized. Examples of speech recognition AI input include noise-reduced MFCC sequences (e.g., 300 frames×39 dimensions), audio spectrogram images (e.g., 128×300 pixels). Examples of speech recognition AI output include UTF-8 encoded text strings (e.g., “A fire has occurred. Please evacuate.”), confidence scores (e.g., 0.95), and per-word confidence distributions (e.g., 0.90-0.99 for each word). As subsequent processing, when the output text exceeds a certain confidence threshold (e.g., 0.95), the recognition unit immediately transfers it to the notification unit, which executes screen display or vibration notification. The recognition unit uses Attention mechanisms or CTC (Connectionist Temporal Classification) within the model to optimize alignment between audio and character sequences and reduce misrecognition. Furthermore, the recognition unit can utilize transfer learning and online learning to adapt to emergency broadcast-specific vocabulary and intonation. As a technical effect, emotion estimation and recognition speed control by the recognition unit enable optimal recognition speed and accuracy according to the user's psychological state and situation compared to conventional uniform speech recognition, making it possible to achieve both real-time performance and reduced misrecognition. Specific application fields include emergency broadcasts during disasters, information transmission with stress management in medical and educational settings, and personalized speech recognition services according to user status.

The recognition unit determines the priority of recognition based on the source of the emergency broadcast during speech recognition. For example, in the case of emergency broadcasts from government agencies, speech recognition is performed with the highest priority. For emergency broadcasts from local governments, speech recognition is performed with the next highest priority. For emergency broadcasts from private companies, speech recognition is performed with normal priority. Thus, by determining the priority of recognition based on the source, important information can be recognized quickly. Specifically, the recognition unit acquires emergency broadcast metadata (e.g., source ID, source category label, confidence score) at the time of reception and assigns a priority score for each source. Examples of AI input include audio feature vector sequences (e.g., 300 frames×39 dimensions of MFCC) and source category (e.g., “government agency”, “local government”, “private company”). For broadcasts with high priority (e.g., government agency), the recognition unit immediately executes inference with the speech recognition model and expands the beam search width to maximize recognition accuracy. For broadcasts with medium priority, standard parameters are used for inference; for broadcasts with low priority, batch processing or low-resource mode is used for inference. Examples of AI output include UTF-8 encoded text strings (e.g., “An earthquake has occurred. Please evacuate.”), confidence scores (e.g., 0.98), and per-word confidence distributions (e.g., 0.90-0.99 for each word). As subsequent processing, when the output text exceeds a certain confidence threshold (e.g., 0.95), the recognition unit immediately transfers it to the notification unit, which executes screen display or vibration notification. The recognition unit applies different model parameters and Attention mechanism weights for each source to reduce misrecognition of important information. Furthermore, the recognition unit can flexibly respond to changes in broadcast content by adding vocabulary and online learning for each source. As a technical effect, source-based control of recognition priority by the recognition unit enables immediate recognition of important information and prevention of misrecognition compared to conventional uniform speech recognition, greatly improving the reliability and real-time performance of emergency information transmission. Specific application fields include emergency broadcasts during disasters, source-specific information transmission in medical and disaster prevention fields, and priority-controlled speech recognition services in industrial settings.

The recognition unit adjusts the order of recognition based on the relevance of the emergency broadcast during speech recognition. For example, emergency broadcasts related to the user's current location information are recognized with the highest priority. Emergency broadcasts highly relevant to the user's past reception history are preferentially recognized. Furthermore, emergency broadcasts highly relevant to the user's social media activity are preferentially recognized. Thus, by adjusting the order of recognition based on relevance, important information can be preferentially recognized. Specifically, the recognition unit integrates emergency broadcast metadata (e.g., target region code, category, source information), user's current location (e.g., latitude, longitude, building ID), past reception history (e.g., reception time, category, reaction log), and social media activity (e.g., post text, hashtags, event participation history), and inputs them into an AI model (e.g., Transformer-based relevance estimation model). Examples of AI input include current latitude and longitude vectors (e.g., 35.6895, 139.6917), reception history vectors for the past 30 days (e.g., 30×10 dimensions), and the most recent 100 post texts (e.g., “#earthquake #evacuation”). The AI outputs relevance scores for each emergency broadcast (e.g., 0.98, 0.85, 0.60), and the recognition unit prioritizes speech recognition processing in order of high relevance scores. Examples of AI output include “current location is within earthquake warning area: relevance 0.98”, “good reaction to fire broadcast in the past: relevance 0.90”, “high frequency of #typhoon tag: relevance 0.85”. As subsequent processing, the recognition unit immediately performs inference for broadcasts with high relevance scores, and processes broadcasts with low relevance scores in batch or at a later time. The recognition unit updates the parameters of the relevance estimation model through online learning to flexibly respond to changes in user behavior and interests. As a technical effect, relevance-based control of recognition order by the recognition unit enables immediate transmission of truly necessary information to users and prevention of misrecognition compared to conventional uniform speech recognition, greatly improving the efficiency of information transmission and user satisfaction. Specific application fields include area-limited emergency broadcasts in urban areas and large facilities, personalized alert services, and SNS-linked disaster information delivery.

The notification unit includes a method of estimating a user's emotion and adjusting the method of expressing notifications based on the estimated emotion. For example, if the user is tense, a simple and highly visible notification method is provided. If the user is relaxed, a notification method including detailed information is provided. Furthermore, if the user is in a hurry, a notification method focusing on key points is provided. Thus, by adjusting the method of expressing notifications according to the user's emotion, more appropriate notifications can be provided. Emotion estimation is realized using, for example, an emotion engine or generative AI with emotion estimation functions. Generative AI may include text generation AI (e.g., LLM) or multimodal generative AI, but is not limited to these examples. Specifically, the notification unit acquires multimodal data such as the user's facial images (224×224 pixel RGB), audio waveforms (3 seconds, 16 kHz), text input (e.g., “I'm tense now”), and heart rate time series (60 seconds, 1 Hz sampling) via device sensors or application interfaces, and inputs them into a neural network for emotion estimation (e.g., multimodal Transformer or convolutional+RNN hybrid model). Examples of AI input include combinations of facial images, audio, text, and biometric signals, or single-modal data (e.g., audio only, facial image only). The AI outputs emotion labels (e.g., “tension”, “relaxation”, “in a hurry”), emotion intensity scores (e.g., tension 0.85, relaxation 0.10), and estimation confidence (e.g., 0.92). The notification unit dynamically determines the method of expressing notifications based on AI output. For example, if the tension level is high, the notification unit uses the device's screen display API to display only minimal text in a large font and high contrast at the center, and generates short continuous vibration using the vibration control API. If relaxed, detailed explanations, supplementary information, and related icons are added, and additional information links or FAQ buttons are displayed at the bottom of the screen. If in a hurry, only key points are emphasized in bold, and the notification content is summarized in three lines or less. AI-based optimization of notification expression enables information transmission tailored to the user's psychological state and situation compared to conventional uniform notification display, greatly improving information receptivity, understanding, and stress reduction. The AI model uses pre-trained weights and can continuously improve emotion estimation accuracy and notification expression optimization algorithms for each user through transfer learning and online learning. The notification unit also refers to the user's past notification history and reaction logs (e.g., number of screen taps after notification, time until notification dismissal) to enhance personalization of expression methods. Specific application fields include emergency broadcast notifications during disasters, information transmission with stress management in medical and educational settings, personalized notification services according to user status, and optimized notifications for diverse user attributes in public facilities and transportation. As a technical effect, emotion estimation and notification expression optimization by the notification unit greatly improve information receptivity, understanding, and stress reduction for each user compared to conventional uniform notification display, enhancing the reliability and immediacy of emergency information transmission.

The notification unit adjusts the level of detail of notifications at the time of notification based on the importance of the emergency broadcast. For example, in the case of a highly important emergency broadcast, the notification unit provides a detailed notification. In the case of a less important emergency broadcast, it provides a concise notification. Furthermore, for emergency broadcasts of moderate importance, it provides notifications with an appropriate level of detail. By adjusting the notification detail level according to the importance of the emergency broadcast, appropriate information can be provided. Specifically, the notification unit acquires metadata of the emergency broadcast (e.g., importance score 0.0-1.0, category label, source information, etc.) at the time of reception and dynamically determines the level of detail of the notification content according to the importance score. Examples of AI input include the importance score of the emergency broadcast (e.g., 0.95), broadcast category (e.g., earthquake, fire, typhoon), notification history vector (e.g., content of the past 30 notifications and user responses), and so on. The AI outputs the optimal notification detail level (e.g., detailed, standard, simple) and display elements (e.g., main text, supplementary explanation, illustration, FAQ link, etc.) based on this information. When the importance is high, the notification unit uses a screen display API to show detailed explanatory text, evacuation procedures, maps, related links, etc., in large font and high contrast, and generates strong continuous vibration using a vibration control API. For moderate importance, only the main text summarizing the key points and simple supplementary information are displayed, and the vibration is set to a moderate intermittent pattern. For low importance, only the notification title and a one-line summary are displayed in a smaller font, and vibration is omitted or kept short. The AI model learns from the user's past notification history and response logs, and continuously optimizes the notification detail selection algorithm online to provide the optimal notification detail level for each user. As a technical effect, importance-based notification detail control by the notification unit achieves both optimal resource allocation and improved information transmission accuracy compared to conventional uniform notification displays, thereby preventing misrecognition of important information and improving user satisfaction. Specific application fields include emergency broadcasts during disasters, transmission of important information in medical and educational settings, and personalized notification services according to user status.

The notification unit applies different notification methods according to the category of the emergency broadcast at the time of notification. For example, in the case of an emergency broadcast related to an earthquake, the notification unit provides a notification method that emphasizes earthquake-related information. In the case of a fire-related emergency broadcast, it provides a notification method that emphasizes fire-related information. Furthermore, for a typhoon-related emergency broadcast, it provides a notification method that emphasizes typhoon-related information. By applying notification methods according to the category, the content of the emergency broadcast can be effectively communicated. Specifically, the notification unit acquires category information of the emergency broadcast (e.g., labels such as earthquake, fire, typhoon, etc.) at the time of reception and automatically selects optimized notification templates and display elements for each category. Examples of AI input include broadcast category labels (e.g., “earthquake”), notification history vectors (e.g., content and user responses for the past 30 category-specific notifications), and user attributes (e.g., visual impairment, device type). The AI outputs the optimal notification method for each category (e.g., earthquake category: earthquake icon and evacuation route map; fire category: fire icon and fire extinguishing procedures; typhoon category: route map and storm warning message, etc.) based on this information. The notification unit switches colors, icons, emphasis (e.g., yellow background for earthquake, red for fire, blue for typhoon), notification sounds, and vibration patterns according to the category. Furthermore, it automatically generates explanatory text including category-specific vocabulary and technical terms to enhance user understanding. The AI model learns from the user's past category-specific notification history and response logs, and continuously optimizes the notification method selection algorithm online to provide the optimal category notification for each user. As a technical effect, the application of category-adaptive notification methods by the notification unit greatly improves the accuracy of specialized information transmission and prevents misrecognition compared to conventional generic notifications, thereby significantly enhancing the reliability of emergency information transmission. Specific application fields include emergency broadcasts during disasters, transmission of information containing technical terms in medical and disaster prevention fields, and category-specialized notification services in industrial settings.

The notification unit includes a method of estimating the user's emotion and adjusting the timing of notifications based on the estimated emotion. For example, if the user is tense, the notification timing is delayed and the notification is sent when the user is calm. If the user is relaxed, the notification is sent immediately. Furthermore, if the user is in a hurry, the most important information is notified preferentially. By adjusting the notification timing according to the user's emotion, notifications can be provided at more appropriate times. Emotion estimation is realized using, for example, an emotion engine or generative AI with emotion estimation functions. Generative AI may include text generation AI (e.g., LLM) or multimodal generative AI, but is not limited to these examples. Specifically, the notification unit acquires multimodal data such as the user's facial image (224×224 pixel RGB), audio waveform (3 seconds at 16 kHz), text input (e.g., “I am tense now”), and heart rate time series (60 seconds at 1 Hz sampling) via device sensors or application interfaces, and inputs them into a neural network for emotion estimation (e.g., multimodal Transformer or convolutional +RNN hybrid model). Examples of AI input include combinations of facial image, audio, text, and biometric signals, as well as single-modal data. The AI outputs emotion labels (e.g., “tense,” “relaxed,” “in a hurry”), emotion intensity scores (e.g., tense 0.85, relaxed 0.10), and estimation confidence (e.g., 0.92) based on this data. The notification unit dynamically applies a notification timing control algorithm based on the AI output. For example, if the tension level is high, notification is delayed by 5 minutes and executed when the user's stress decreases. When relaxed, notification is immediate; when in a hurry, only the most important information is notified preferentially, and detailed information is postponed. The notification unit also refers to the user's past notification history and response logs (e.g., number of screen taps after notification, time until notification dismissal) and optimizes the timing control algorithm through online learning. As a technical effect, emotion estimation and notification timing control by the notification unit reduce the user's psychological burden and maximize information receptivity and responsiveness compared to conventional uniform notification timing. Specific application fields include medical and educational settings where stress management is important, panic prevention during disasters, and individually optimized information delivery services.

The notification unit selects an appropriate notification method by considering the user's device information at the time of notification. For example, if the user is using a smartphone, the notification unit provides a method of displaying text on the screen. If the user is using a tablet, it provides a notification method optimized for the larger screen. Furthermore, if the user is using a smartwatch, it provides a method of notifying by vibration. By considering device information, the optimal notification method can be provided. Specifically, the notification unit acquires device information in real time (e.g., device type, screen size, OS version, battery level, hardware features, etc.) and automatically selects notification templates and display elements optimized for each device. Examples of AI input include device type (e.g., smartphone, tablet, smartwatch), screen resolution (e.g., 1080×1920), battery level (e.g., 80%), hardware features (e.g., vibration availability, audio output capability), and so on. The AI outputs the optimal notification method (e.g., smartphone: large font in the center of the screen+vibration; tablet: split screen+detailed information; smartwatch: short text+vibration only) based on this information. The notification unit automatically adjusts notification sounds, vibration patterns, font size, color scheme, and layout for each device, and personalizes the notification method by referring to the user's device usage and past notification history. As a technical effect, device information-based notification method optimization by the notification unit greatly improves the certainty and immediacy of information transmission according to device characteristics and user usage compared to conventional uniform notification displays. Specific application fields include emergency broadcast notifications in multi-device environments, non-visual notifications on wearable devices, and multi-device collaborative information delivery in public facilities and transportation systems.

The notification unit selects an appropriate notification method by referring to the user's past notification history at the time of notification. For example, the notification unit preferentially provides notification methods that the user has preferred in the past. It also proposes the optimal notification method for specific time periods based on the user's past notification history. Furthermore, it analyzes the user's past notification history to select the most effective notification method. By referring to past notification history, the optimal notification method can be selected. Specifically, the notification unit maintains a notification history database for each user (e.g., structured data including notification time, notification method, device type, user response logs, etc.) and inputs these history data as time-series vectors (e.g., one year of notification events ×10 attributes per event) into the AI model. Examples of AI input include notification history vectors for the past 30 days (e.g., 30×10 dimensions, each row representing notification time, method, user response, etc.), frequency distribution of notifications for specific categories (e.g., earthquake, fire), and user operation logs after notifications (e.g., number of screen taps within 30 seconds after notification, time until notification dismissal). The AI inputs these history data into convolutional neural networks, recurrent neural networks specialized for time-series processing, or Transformer-based time-series analysis models, and extracts notification tendencies and response patterns for each user. Examples of AI output include priority notification method labels (e.g., screen display+vibration priority 0.95, audio notification priority 0.85), optimal notification timing (e.g., weekdays 18:00-22:00), and recommended notification detail level (e.g., font size 36 pt, with detailed explanation). The notification unit automatically selects the optimal notification method, detail level, and timing at the time of notification based on the AI output. For example, for users who have shown poor response to nighttime notifications in the past, notifications can be sent by vibration only at night and displayed on the screen again in the morning. The notification unit continuously learns from the user's notification and response history and updates model parameters online to flexibly adapt to changes in the user's lifestyle and preferences. As a technical effect, history analysis and notification method optimization by the notification unit maximize information receptivity and responsiveness for each user compared to conventional uniform notification displays, greatly improving the efficiency of emergency broadcast transmission and user satisfaction. Specific application fields include emergency broadcast notifications in private homes and apartment complexes, individualized optimization of organizational broadcasts in companies and schools, and personalized information delivery services according to user attributes.

The system according to the embodiment is not limited to the examples described above and can be variously modified as follows. Specifically, the system can change the architecture of the speech recognition model and emotion estimation model. For example, in the speech recognition unit, convolutional neural networks, recurrent neural networks, Transformer-based models, self-supervised learning models, or ensembles of multiple models can be used. In the emotion estimation unit, multimodal AI models using any combination of image, audio, text, and biometric signals can be applied. In the notification unit, various notification means such as screen display, vibration, speech synthesis, LED blinking, and signal transmission to IoT-linked devices can be combined. Furthermore, learning methods such as distributed inference in the cloud, edge inference on the device, personalized learning for each user, transfer learning, online learning, and federated learning can be selected. As for data flow, audio data, emotion data, location information, history data, etc., can be encrypted and transmitted to enhance privacy protection. The AI model output can take various forms, such as text strings, confidence scores, category labels, recommended detail levels, and recommended notification timing values. In subsequent processing, notification method, detail level, timing, priority, etc., are automatically controlled based on the output results, and the system as a whole is optimized by continuously learning from user response logs. As a technical effect, these variations greatly improve flexibility, scalability, and adaptability compared to conventional fixed information transmission systems, enabling advanced emergency broadcast notification services that can promptly respond to diverse user needs and changing situations. Specific application fields include emergency broadcasts during disasters, information transmission in medical, educational, and industrial settings, IoT-linked smart home alarms, and personalized information delivery services.

The reception unit can also acquire the user's biometric information and adjust the timing of receiving emergency broadcasts. For example, by monitoring the user's heart rate and blood pressure, if an abnormality is detected, the reception of emergency broadcasts can be temporarily delayed. If the user is exercising, the reception of emergency broadcasts can be postponed until the exercise is finished. Furthermore, if the user is sleeping, the reception of emergency broadcasts can be adjusted to occur after waking up. In this way, the timing of receiving emergency broadcasts can be optimized based on the user's biometric information. Specifically, the reception unit acquires biometric information in real time from devices or wearable devices, such as heart rate (e.g., 1 Hz sampling), blood pressure (e.g., every minute), activity level (e.g., accelerometer values), and sleep state (e.g., estimated from accelerometer+heart rate variability), and inputs these time-series data into an AI model for biometric information analysis (e.g., LSTM-based time-series anomaly detection model or multimodal Transformer). Examples of AI input include heart rate time series for the last 60 seconds (e.g., 60×1 dimension), blood pressure values (e.g., 120/80 mmHg), activity vector (e.g., 3-axis acceleration for 60 seconds), and sleep determination label (e.g., “sleeping,” “awake”). The AI outputs anomaly detection labels (e.g., “heart rate abnormality,” “exercising,” “sleeping”), anomaly score (e.g., 0.92), and estimation confidence (e.g., 0.95) based on this data. The reception unit controls the timing of receiving emergency broadcasts based on the AI output. For example, during heart rate abnormality, reception is delayed by 10 minutes; during exercise, notification is sent after exercise ends; during sleep, notification is sent after waking is detected. The reception unit also refers to the user's past biometric information history and emergency broadcast response history, and optimizes the timing control algorithm through online learning. As a technical effect, biometric information-based reception timing control by the reception unit achieves optimal information transmission according to the user's health status and activity, balancing reduction of psychological and physical burden with improved information receptivity compared to conventional uniform information delivery. Specific application fields include emergency broadcast notifications for medical settings and the elderly, personalized information delivery during sports or sleep, and IoT-linked alarm services with health management.

The notification unit can also adjust the notification method according to the degree of the user's visual impairment. For example, if the visual impairment is severe, audio notification is prioritized. If the visual impairment is mild, the font size of the text is increased and contrast is enhanced to improve visibility. Furthermore, if the user has color vision deficiency, the color combination can be adjusted to display the notification content. In this way, appropriate notification methods can be provided according to the degree of visual impairment. Specifically, the notification unit acquires the user's disability information (e.g., visual impairment level, type of color vision deficiency, low vision, total blindness, etc.) from the user profile or device settings and inputs it into the notification method selection AI model. Examples of AI input include visual impairment level (e.g., severe, moderate, mild), type of color vision deficiency (e.g., red-green, blue-yellow, total color blindness), device type (e.g., smartphone, tablet), and past notification history (e.g., frequency of audio notification use). The AI outputs the optimal notification method (e.g., severe: speech synthesis notification; mild: large font+high contrast; color vision deficiency: automatic color combination adjustment) based on this information. The notification unit uses a speech synthesis API to automatically read out the notification content, and a screen display API to automatically adjust font size (e.g., 36 pt-72 pt), contrast ratio (e.g., black text on white background, blue text on yellow background), and color scheme (e.g., color vision deficiency-compatible palette). Furthermore, the notification unit learns from the user's past notification response logs (e.g., number of audio notification playbacks, number of screen magnification operations) and updates the notification method selection algorithm online. As a technical effect, optimization of notification methods for visual impairment by the notification unit greatly improves the certainty and immediacy of information transmission according to disability characteristics compared to conventional uniform notification displays. Specific application fields include emergency broadcast notifications for visually impaired and elderly users, accessibility enhancement in public facilities and transportation, and personalized information delivery services for users with color vision deficiency.

The recognition unit may also be equipped with a function to remove background noise when analyzing emergency broadcast audio. For example, when an emergency broadcast is received in a noisy environment, noise canceling technology is used to clarify the audio. By filtering specific noises such as wind or traffic sounds, the accuracy of speech recognition is improved. Furthermore, when multiple sound sources are mixed, the emergency broadcast audio can be preferentially extracted. In this way, the influence of background noise is minimized, enabling accurate speech recognition. Specifically, the recognition unit receives audio data (e.g., 16 kHz, 16 bit, mono PCM) as input, applies spectral subtraction, Wiener filtering, and self-supervised noise suppression neural networks (e.g., Denoising Autoencoder, U-Net-based models, etc.) in the preprocessing unit to reduce noise components. Examples of AI input include noisy audio waveforms (e.g., 3 seconds at 16 kHz), spectrogram images (e.g., 128×300 pixels), and noise labels (e.g., “wind,” “traffic,” “crowd”). The AI outputs noise-reduced audio waveforms, estimated noise component masks, and noise residual scores (e.g., 0.05) based on this data. The recognition unit extracts features such as MFCC from the noise-reduced audio and inputs them into a speech recognition model (e.g., Transformer-based, RNN-based, etc.). When multiple sound sources are mixed, a source separation AI (e.g., Blind Source Separation model) is applied to extract only the emergency broadcast audio. Examples of AI output include noise-reduced audio waveforms, confidence scores for extracted audio (e.g., 0.98), and source separation labels (e.g., “emergency broadcast,” “environmental sound”). As a technical effect, the introduction of noise removal and source separation functions by the recognition unit enables highly accurate speech recognition even in complex environments, greatly improving the reliability and immediacy of emergency information transmission compared to conventional simple filtering. Specific application fields include emergency broadcasts in noisy environments during disasters, automatic recognition of in-house broadcasts in transportation and commercial facilities, and audio information transmission at outdoor events.

The notification unit can also estimate the user's emotion and customize the notification content based on the estimated emotion. For example, if the user is feeling anxious, a reassuring message is added. If the user is excited, a message encouraging calmness is displayed. Furthermore, if the user is tired, concise and easy-to-understand notification content is provided. In this way, appropriate notification content can be provided according to the user's emotion. Specifically, the notification unit acquires multimodal data such as the user's facial image (224×224 pixel RGB), audio waveform (3 seconds at 16 kHz), text input (e.g., “I am anxious now”), and heart rate time series (60 seconds at 1 Hz sampling), and inputs them into a neural network for emotion estimation (e.g., multimodal Transformer or convolutional+RNN hybrid model). Examples of AI input include combinations of facial image, audio, text, and biometric signals, as well as single-modal data. The AI outputs emotion labels (e.g., “anxiety,” “excitement,” “fatigue”), emotion intensity scores (e.g., anxiety 0.85, excitement 0.10), and estimation confidence (e.g., 0.92) based on this data. The notification unit inputs the emergency broadcast main text and emotion label into a notification content generation AI (e.g., LLM or template generation model) based on the AI output, and automatically generates supplementary text to provide reassurance (e.g., “Please remain calm”), messages to encourage calmness (e.g., “Take a deep breath and follow the instructions”), and concise summaries (e.g., “Display only evacuation instructions”). The notification unit also refers to the user's past notification history and response logs and optimizes the notification content customization algorithm through online learning. As a technical effect, emotion-adaptive notification content generation by the notification unit greatly improves the certainty, reassurance, and understanding of information transmission according to the user's psychological state compared to conventional uniform notification texts. Specific application fields include emergency broadcasts during disasters, information transmission with stress management in medical and educational settings, and personalized notification services according to user status.

The reception unit can also monitor the battery level of the user's device and adjust the method of receiving emergency broadcasts. For example, if the battery level is low, emergency broadcasts are received in low-power mode. If the battery level is insufficient, the notification method is simplified to reduce battery consumption. Furthermore, if the battery level is extremely low, the reception of emergency broadcasts can be temporarily stopped and resumed after charging is complete. In this way, the optimal reception method can be provided according to the device's battery level. Specifically, the reception unit acquires the device's battery level (e.g., obtained in 1% increments), charging status (e.g., charging/not charging), and power consumption history (e.g., average consumption in mAh over the past hour) in real time, and inputs them into a battery management AI model (e.g., time-series LSTM or rule-based model). Examples of AI input include current battery level (e.g., 15%), charging status (e.g., not charging), power consumption history (e.g., consumption per minute for 60 minutes), and device type (e.g., smartphone, tablet). The AI outputs the optimal reception mode (e.g., low-power mode, normal mode, temporary reception suspension) and notification method (e.g., screen display only, vibration omitted, audio notification omitted) based on this information. The reception unit simplifies voice recognition and notification processing in low-power mode when battery level is below 20%, minimizes notification methods when below 10%, and temporarily suspends emergency broadcast reception when below 5%, resuming after charging is complete. The reception unit also refers to the user's past battery history and emergency broadcast response history and optimizes the reception method control algorithm through online learning. As a technical effect, battery level-based reception method optimization by the reception unit achieves both device operation continuity and certainty of information transmission compared to conventional uniform information delivery, greatly improving user convenience and safety. Specific application fields include emergency broadcast notifications during power outages in disasters, low-power information delivery to users on the go, and battery management alarm services for IoT devices and wearable devices.

The recognition unit can also estimate the user's emotion and provide feedback on speech recognition based on the estimated emotion. For example, if the user is feeling anxious, the recognition unit provides a detailed explanation of the speech recognition result to reassure the user. If the user is excited, it provides feedback encouraging calmness. Furthermore, if the user is tired, concise and easy-to-understand feedback is provided. In this way, appropriate feedback can be provided according to the user's emotion. Specifically, the recognition unit acquires multimodal data such as the user's facial image (224×224 pixel RGB), audio waveform (3 seconds at 16 kHz), text input (e.g., “I am anxious now”), and heart rate time series (60 seconds at 1 Hz sampling), and inputs them into a neural network for emotion estimation (e.g., multimodal Transformer or convolutional+RNN hybrid model). Examples of AI input include combinations of facial image, audio, text, and biometric signals, as well as single-modal data. The AI outputs emotion labels (e.g., “anxiety,” “excitement,” “fatigue”), emotion intensity scores (e.g., anxiety 0.85, excitement 0.10), and estimation confidence (e.g., 0.92) based on this data. The recognition unit inputs the recognition result and emotion label into a feedback generation AI for speech recognition results (e.g., LLM or template generation model) based on the AI output, and automatically generates detailed explanations (e.g., “Speech recognition result: An earthquake has occurred. Please evacuate. Confidence 0.98. The possibility of misrecognition is low.”), messages to encourage calmness (e.g., “Please remain calm and follow the instructions”), and concise summaries (e.g., “Emphasize only evacuation instructions”). The recognition unit also refers to the user's past feedback history and response logs and optimizes the feedback generation algorithm through online learning. As a technical effect, emotion-adaptive feedback generation by the recognition unit greatly improves the certainty, reassurance, and understanding of information transmission according to the user's psychological state compared to conventional uniform recognition result displays. Specific application fields include emergency broadcasts during disasters, information transmission with stress management in medical and educational settings, and personalized speech recognition services according to user status.

The notification unit can also learn the user's past behavioral patterns and propose optimal notification timing. For example, if the user wakes up at a specific time every morning, emergency broadcasts are notified at that time. If the user is at a specific location on a specific day of the week, emergency broadcasts related to that location are preferentially notified. Furthermore, if the user is busy during a specific time period, notifications can be sent at other times. In this way, optimal notification timing can be provided based on the user's behavioral patterns. Specifically, the notification unit inputs the user's behavioral history data (e.g., wake-up and sleep times, movement history, device usage, calendar events, etc.) as time-series vectors (e.g., one year of behavioral events ×10 attributes per event) into the AI model. Examples of AI input include wake-up time vectors for the past 30 days (e.g., 30×1 dimension), movement history by day of the week (e.g., 7×10 dimensions), device usage logs (e.g., app launch times, screen ON/OFF counts), and calendar events (e.g., meetings, classes). The AI inputs these history data into time-series analysis models (e.g., LSTM, Transformer, etc.) and outputs optimal notification timing (e.g., weekdays 7:00, Saturday 10:00, after meetings) and notification priority scores (e.g., 0.95). The notification unit automatically adjusts the timing of emergency broadcast notifications based on the AI output, optimizing information transmission according to the user's lifestyle and behavioral patterns. The notification unit continuously learns from the user's past notification response history and changes in lifestyle patterns, and updates model parameters online to maintain optimization accuracy. As a technical effect, behavioral pattern learning-based notification timing optimization by the notification unit greatly improves the certainty and convenience of information transmission according to the user's lifestyle and situation compared to conventional uniform notification timing. Specific application fields include emergency broadcast notifications in private homes and apartment complexes, individualized optimization of organizational broadcasts in companies and schools, and personalized information delivery services according to user attributes.

The reception unit can also estimate the user's emotion and summarize the content of emergency broadcasts based on the estimated emotion. For example, if the user is tense, only the important information is concisely summarized and notified. If the user is relaxed, notifications including detailed information are provided. Furthermore, if the user is in a hurry, the most important points are emphasized in the notification. In this way, emergency broadcasts can be notified with an appropriate amount of information according to the user's emotion. Specifically, the reception unit acquires multimodal data such as the user's facial image (224×224 pixel RGB), audio waveform (3 seconds at 16 kHz), text input (e.g., “I am tense now”), and heart rate time series (60 seconds at 1 Hz sampling), and inputs them into a neural network for emotion estimation (e.g., multimodal Transformer or convolutional+RNN hybrid model). Examples of AI input include combinations of facial image, audio, text, and biometric signals, as well as single-modal data. The AI outputs emotion labels (e.g., “tense,” “relaxed,” “in a hurry”), emotion intensity scores (e.g., tense 0.85, relaxed 0.10), and estimation confidence (e.g., 0.92) based on this data. The reception unit inputs the emergency broadcast main text and emotion label into a summary generation AI (e.g., LLM or template generation model) based on the AI output, and automatically generates concise summaries containing only important information (e.g., “Earthquake occurred, evacuation instructions”), detailed explanations (e.g., “Seismic intensity, evacuation route, precautions”), and point emphasis (e.g., “Display evacuation instructions with highest priority”). The reception unit also refers to the user's past notification history and response logs and optimizes the summary generation algorithm through online learning. As a technical effect, emotion-adaptive summary generation by the reception unit greatly improves the certainty, understanding, and stress reduction of information transmission according to the user's psychological state and situation compared to conventional uniform information notifications. Specific application fields include emergency broadcasts during disasters, information transmission with stress management in medical and educational settings, and personalized notification services according to user status.

The notification unit can also monitor the usage status of the user's device and select the optimal notification method. For example, if the user is using a smartphone, the notification unit provides a method of displaying text on the screen. If the user is using a smartwatch, it provides a method of notifying by vibration. Furthermore, if the user is using a personal computer, it can display desktop notifications. In this way, the optimal notification method can be provided according to the device usage status. Specifically, the notification unit acquires device usage status (e.g., active apps, screen ON/OFF status, connected device type, user operation logs, etc.) in real time and inputs them into a usage status analysis AI model (e.g., time-series LSTM or rule-based model). Examples of AI input include current active device (e.g., smartphone, smartwatch, personal computer), screen status (e.g., ON/OFF), active app name (e.g., messaging, browser), and user operation history (e.g., number of taps/clicks in the last 10 minutes). The AI outputs the optimal notification method (e.g., smartphone: screen display; smartwatch: vibration; personal computer: desktop notification) based on this information. The notification unit automatically adjusts notification sounds, vibration patterns, font size, color scheme, and layout for each device, and personalizes the notification method by referring to the user's device usage status and past notification history. As a technical effect, notification method optimization based on device usage status by the notification unit greatly improves the certainty and immediacy of information transmission according to device usage and user behavior compared to conventional uniform notification displays. Specific application fields include emergency broadcast notifications in multi-device environments, non-visual notifications on wearable devices, and desktop-linked information delivery in offices and homes.

The recognition unit can also estimate the user's emotion and emphasize the results of speech recognition based on the estimated emotion. For example, if the user is feeling anxious, important information is emphasized to provide reassurance. If the user is excited, information encouraging calmness is emphasized. Furthermore, if the user is tired, concise and easy-to-understand information is emphasized. In this way, appropriate information can be provided according to the user's emotion. Specifically, the recognition unit acquires multimodal data such as the user's facial image (224×224 pixel RGB), audio waveform (3 seconds at 16 kHz), text input (e.g., “I am anxious now”), and heart rate time series (60 seconds at 1 Hz sampling), and inputs them into a neural network for emotion estimation (e.g., multimodal Transformer or convolutional+RNN hybrid model). Examples of AI input include combinations of facial image, audio, text, and biometric signals, as well as single-modal data. The AI outputs emotion labels (e.g., “anxiety,” “excitement,” “fatigue”), emotion intensity scores (e.g., anxiety 0.85, excitement 0.10), and estimation confidence (e.g., 0.92) based on this data. The recognition unit applies a speech recognition result emphasis control algorithm based on the AI output, and emphasizes important information (e.g., “evacuation instructions”) by bolding, coloring, or adding icons. When calmness is needed, supplementary text encouraging calm behavior is emphasized, and when fatigued, only the key points are displayed concisely in large font. The recognition unit also refers to the user's past notification history and response logs and optimizes the emphasis display algorithm through online learning. As a technical effect, emotion-adaptive emphasis display by the recognition unit greatly improves the certainty, reassurance, and understanding of information transmission according to the user's psychological state and situation compared to conventional uniform information displays. Specific application fields include emergency broadcasts during disasters, information transmission with stress management in medical and educational settings, and personalized speech recognition services according to user status.

The following is a brief explanation of the processing flow of Example of the Embodiment. Specifically, the system operates in cooperation among the reception unit, recognition unit, and notification unit modules, realizing real-time and highly accurate reception and notification of emergency broadcasts on the user's device. The reception unit acquires audio data (e.g., 16 kHz, 16bit, mono PCM) from the device's microphone input, performs noise reduction, volume normalization, and frame segmentation in the preprocessing unit, and converts it into feature vectors such as MFCC (e.g., 13-dimensional MFCC+delta+delta-delta=39 dimensions). The recognition unit inputs these feature sequences (e.g., 300 frames×39 dimensions) into a speech recognition model (e.g., Transformer-based, RNN-based, etc.), and sequentially generates text strings (e.g., “An earthquake has occurred. Please evacuate.”) using CTC or attention mechanisms. Examples of AI input include MFCC sequences and noise-reduced audio waveforms, and examples of AI output include UTF-8 encoded text strings, confidence scores, and confidence distributions for each recognized word. The notification unit displays the output text in large font at the center of the device screen using a screen display API and generates 1.5 seconds of continuous vibration using a vibration control API. The notification unit refers to the user's device settings, past notification history, and emotional state to optimize notification methods (display color, font size, vibration pattern, etc.). The AI-based speech recognition and notification optimization process, unlike conventional manual work or uniform notification displays, performs pattern matching, sequence labeling, and probabilistic inference in a high-dimensional feature space on a high-speed parallel computing cluster, realizing optimal information transmission according to each user's psychological state and device status. As a technical effect, the system can convert the content of emergency broadcasts into text with high accuracy within a few seconds and immediately notify hearing-impaired and diverse users, thereby enabling rapid initial response and improved safety during disasters. Specific application fields include emergency broadcasts during natural disasters such as earthquakes, fires, tsunamis, and typhoons, in-house broadcasts in railways, airports, and commercial facilities, and evacuation instruction broadcasts in schools and hospitals.

Step 1: The reception unit receives an emergency broadcast. For example, the user receives an emergency broadcast via an application. At this time, the user launches the application and operates a button to receive the emergency broadcast with a single touch. For example, when an emergency such as an earthquake or fire occurs, the user only needs to launch the application and press the button to receive the emergency broadcast. Step 2: The recognition unit uses AI to recognize the received audio in real time and convert it into text. For example, when an emergency broadcast such as “An earthquake has occurred. Please evacuate.” is received, the recognition unit analyzes this audio and converts it into the text “An earthquake has occurred. Please evacuate.” Step 3: The notification unit notifies the converted text to hearing-impaired users. Notification methods include displaying text on the smartphone screen and notifying by vibration. For example, the text is displayed on the smartphone screen and the user is notified by vibration at the same time. In this way, the system can notify hearing-impaired users of the content of emergency broadcasts in real time. Specifically, in Step 1, the reception unit acquires audio data (e.g., 16 kHz, 16 bit, mono PCM) from the device's microphone input, performs noise reduction, volume normalization, and frame segmentation in the preprocessing unit, and converts it into feature vectors such as MFCC (e.g., 13-dimensional MFCC+delta+delta-delta=39 dimensions). In Step 2, the recognition unit inputs these feature sequences (e.g., 300 frames×39 dimensions) into a speech recognition model (e.g., Transformer-based, RNN-based, etc.), and sequentially generates text strings (e.g., “An earthquake has occurred. Please evacuate.”) using CTC or attention mechanisms. Examples of AI input include MFCC sequences and noise-reduced audio waveforms, and examples of AI output include UTF-8 encoded text strings, confidence scores, and confidence distributions for each recognized word. In Step 3, the notification unit displays the output text in large font at the center of the device screen using a screen display API and generates 1.5 seconds of continuous vibration using a vibration control API. The notification unit refers to the user's device settings, past notification history, and emotional state to optimize notification methods (display color, font size, vibration pattern, etc.). The AI-based speech recognition and notification optimization process, unlike conventional manual work or uniform notification displays, performs pattern matching, sequence labeling, and probabilistic inference in a high-dimensional feature space on a high-speed parallel computing cluster, realizing optimal information transmission according to each user's psychological state and device status. As a technical effect, the system can convert the content of emergency broadcasts into text with high accuracy within a few seconds and immediately notify hearing-impaired and diverse users, thereby enabling rapid initial response and improved safety during disasters. Specific application fields include emergency broadcasts during natural disasters such as earthquakes, fires, tsunamis, and typhoons, in-house broadcasts in railways, airports, and commercial facilities, and evacuation instruction broadcasts in schools and hospitals.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, recognition unit, and notification unit is implemented by at least one of, for example, the smart device 14 and the data processing apparatus 12. For example, the reception unit is implemented by a control unit 46A of the smart device 14, and the user operates a button via an application to receive emergency broadcasts. The recognition unit is implemented, for example, by a specific processing unit 290 of the data processing apparatus 12, and recognizes received audio in real time using AI and converts it into text. The notification unit is implemented, for example, by the control unit 46A of the smart device 14, displays the converted text on the smartphone screen, and notifies the user by vibration. The correspondence between each unit and the device or control unit is not limited to the above examples, and various modifications are possible.

### Second Embodiment

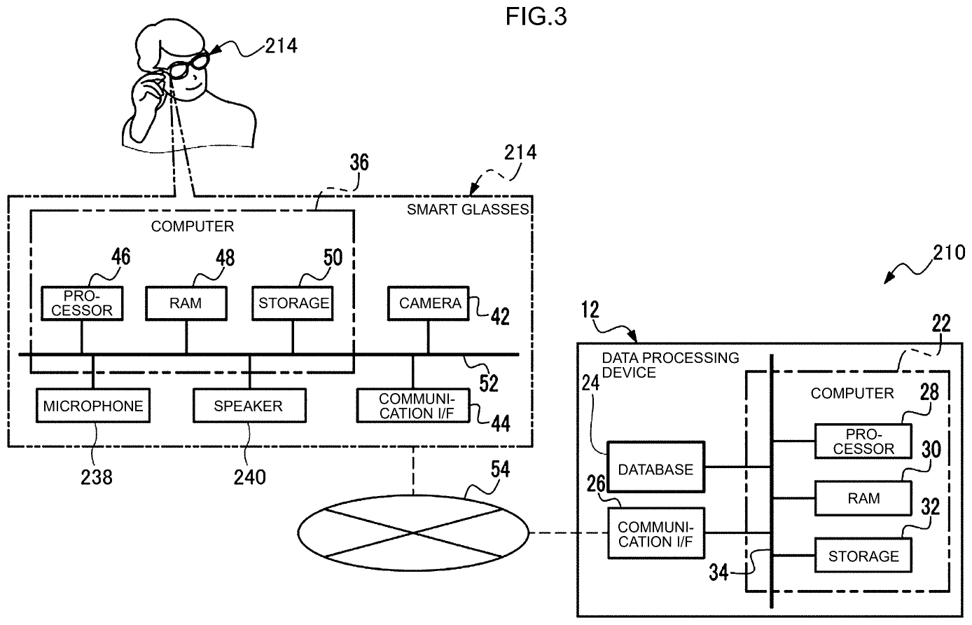

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

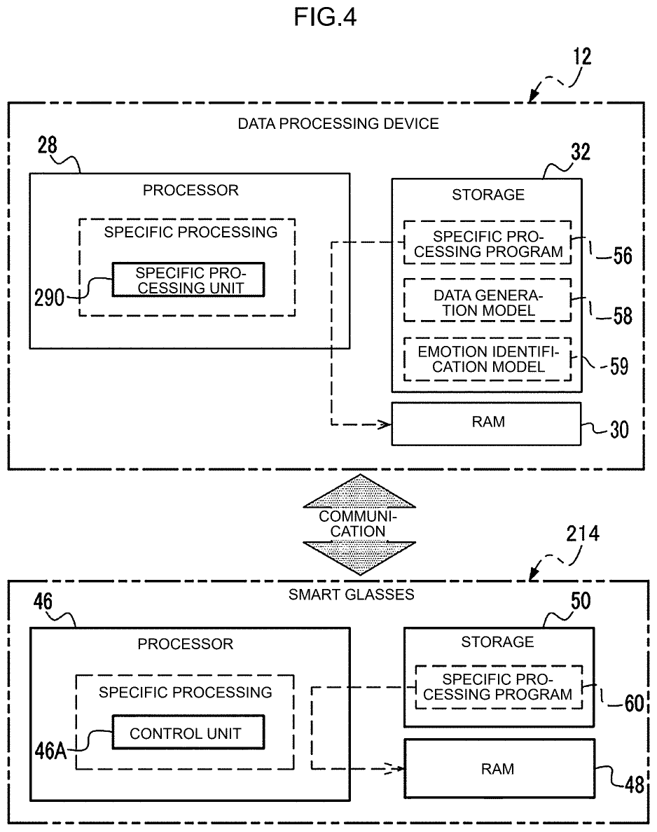

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, recognition unit, and notification unit is implemented by at least one of, for example, the smart glasses 214 and the data processing apparatus 12. For example, the reception unit is implemented by a control unit 46A of the smart glasses 214, and the user operates a button via an application to receive emergency broadcasts. The recognition unit is implemented, for example, by a specific processing unit 290 of the data processing apparatus 12, and recognizes received audio in real time using AI and converts it into text. The notification unit is implemented, for example, by the control unit 46A of the smart glasses 214, displays the converted text on the display of the smart glasses, and notifies the user by vibration. The correspondence between each unit and the device or control unit is not limited to the above examples, and various modifications are possible.

### Third Embodiment

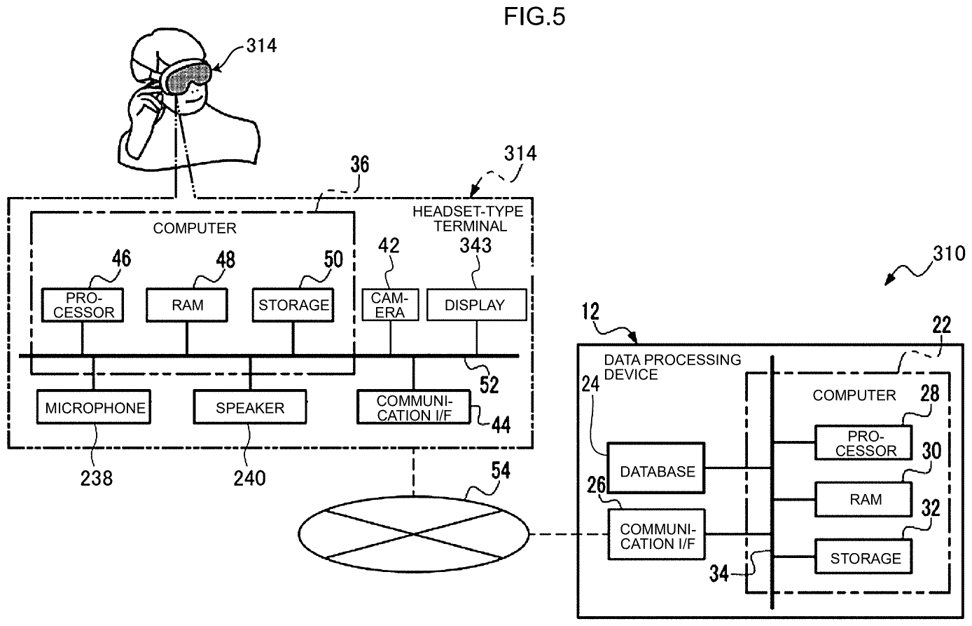

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

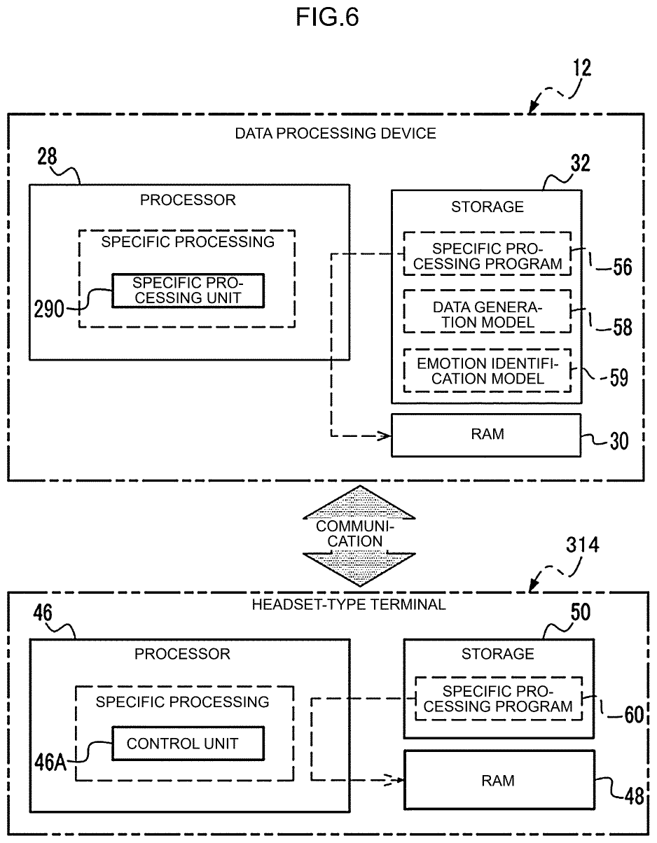

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, recognition unit, and notification unit is implemented by at least one of, for example, the headset-type terminal 314 and the data processing apparatus 12. For example, the reception unit is implemented by a control unit 46A of the headset-type terminal 314, and the user operates a button via an application to receive emergency broadcasts. The recognition unit is implemented, for example, by a specific processing unit 290 of the data processing apparatus 12, and recognizes received audio in real time using AI and converts it into text. The notification unit is implemented, for example, by the control unit 46A of the headset-type terminal 314, displays the converted text on the display of the headset, and notifies the user by vibration. The correspondence between each unit and the device or control unit is not limited to the above examples, and various modifications are possible.

### Fourth Embodiment

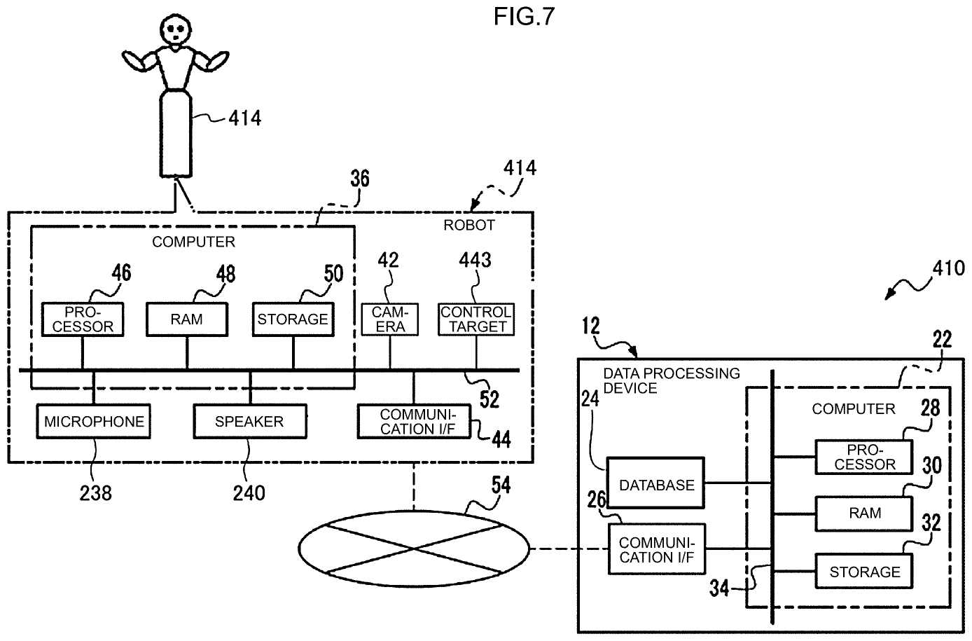

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

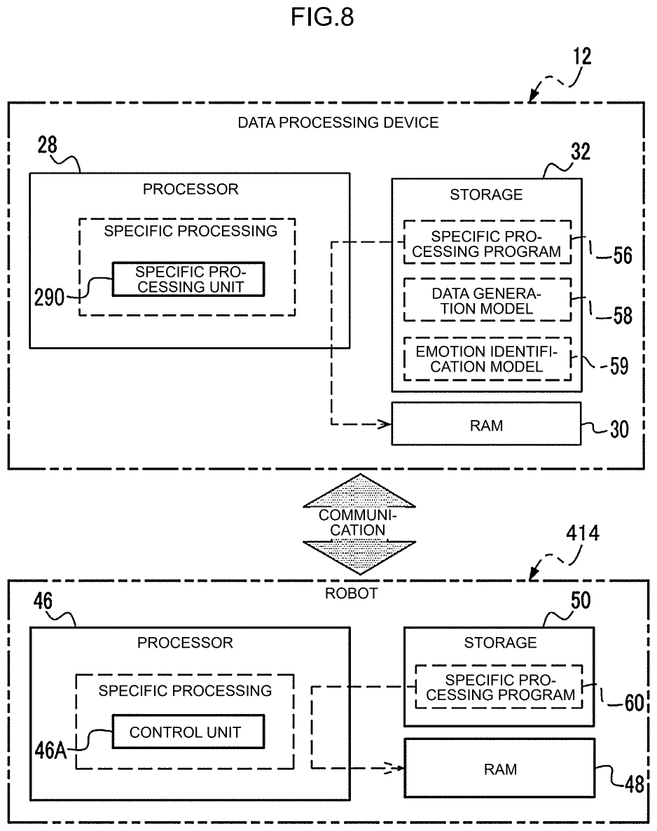

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, recognition unit, and notification unit is implemented by at least one of, for example, the robot 414 and the data processing apparatus 12. For example, the reception unit is implemented by a control unit 46A of the robot 414, and the user operates a button via an application to receive emergency broadcasts. The recognition unit is implemented, for example, by a specific processing unit 290 of the data processing apparatus 12, and recognizes received audio in real time using AI and converts it into text. The notification unit is implemented, for example, by the control unit 46A of the robot 414, displays the converted text on the display of the robot, and notifies the user by vibration. The correspondence between each unit and the device or control unit is not limited to the above examples, and various modifications are possible.

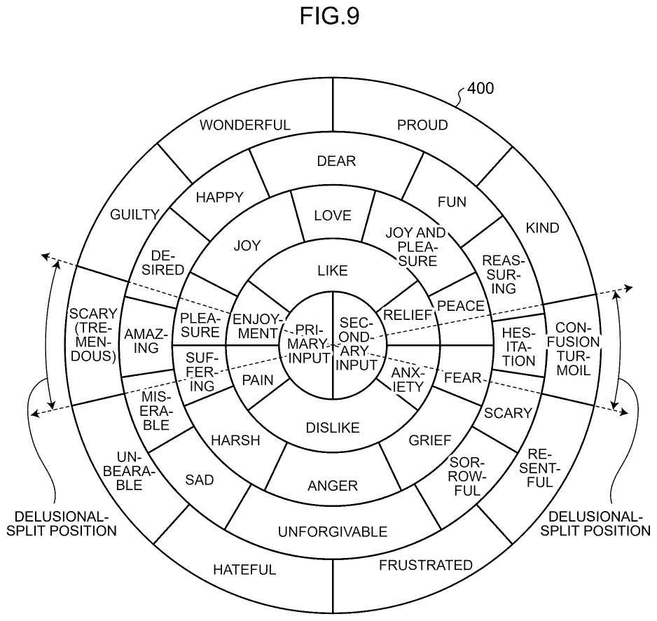

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

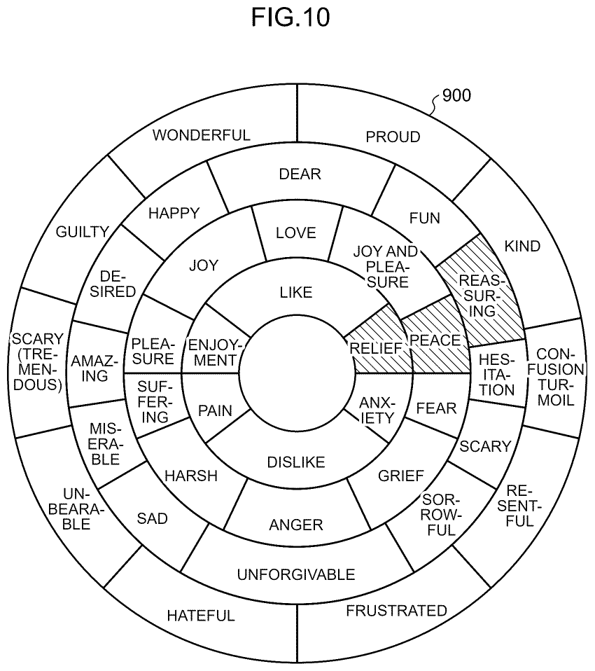

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a reception unit configured to receive emergency broadcasts; a recognition unit configured to recognize audio received by the reception unit in real time and convert it into text; and a notification unit configured to notify the text converted by the recognition unit.
(Supplementary Note 2) The system according to Supplementary Note 1, wherein the notification unit includes a method of displaying text on a smartphone screen.
(Supplementary Note 3) The system according to Supplementary Note 1, wherein the notification unit includes a method of notifying by vibration.
(Supplementary Note 4) The system according to Supplementary Note 1, wherein the recognition unit analyzes received audio using speech recognition technology and converts it into text.
(Supplementary Note 5) The system according to Supplementary Note 1, wherein the recognition unit recognizes audio in real time and converts it into text.
(Supplementary Note 6) The system according to Supplementary Note 1, wherein the reception unit includes a method of estimating a user's emotion and adjusting the timing of receiving emergency broadcasts based on the estimated emotion.
(Supplementary Note 7) The system according to Supplementary Note 1, wherein the reception unit analyzes a user's past emergency broadcast reception history and selects an appropriate reception method.
(Supplementary Note 8) The system according to Supplementary Note 1, wherein the reception unit performs filtering based on the user's current location information and situation when receiving an emergency broadcast.
(Supplementary Note 9) The system according to Supplementary Note 1, wherein the reception unit includes a method of estimating a user's emotion and determining the priority of emergency broadcasts to be received based on the estimated emotion.
(Supplementary Note 10) The system according to Supplementary Note 1, wherein the reception unit preferentially receives highly relevant broadcasts based on the user's geographic location information when receiving emergency broadcasts.
(Supplementary Note 11) The system according to Supplementary Note 1, wherein the reception unit analyzes a user's social media activity when receiving emergency broadcasts and receives relevant broadcasts.
(Supplementary Note 12) The system according to Supplementary Note 1, wherein the recognition unit includes a method of estimating a user's emotion and adjusting the accuracy of speech recognition based on the estimated emotion.
(Supplementary Note 13) The system according to Supplementary Note 1, wherein the recognition unit adjusts the level of detail of recognition based on the importance of the emergency broadcast during speech recognition.
(Supplementary Note 14) The system according to Supplementary Note 1, wherein the recognition unit applies different recognition algorithms according to the category of the emergency broadcast during speech recognition.
(Supplementary Note 15) The system according to Supplementary Note 1, wherein the recognition unit includes a method of estimating a user's emotion and adjusting the speed of speech recognition based on the estimated emotion.
(Supplementary Note 16) The system according to Supplementary Note 1, wherein the recognition unit determines the priority of recognition based on the source of the emergency broadcast during speech recognition.
(Supplementary Note 17) The system according to Supplementary Note 1, wherein the recognition unit adjusts the order of recognition based on the relevance of the emergency broadcast during speech recognition.
(Supplementary Note 18) The system according to Supplementary Note 1, wherein the notification unit includes a method of estimating a user's emotion and adjusting the method of expressing notifications based on the estimated emotion.
(Supplementary Note 19) The system according to Supplementary Note 1, wherein the notification unit adjusts the level of detail of notifications based on the importance of the emergency broadcast when notifying.
(Supplementary Note 20) The system according to Supplementary Note 1, wherein the notification unit applies different notification methods according to the category of the emergency broadcast when notifying.
(Supplementary Note 21) The system according to Supplementary Note 1, wherein the notification unit includes a method of estimating a user's emotion and adjusting the timing of notifications based on the estimated emotion.
(Supplementary Note 22) The system according to Supplementary Note 1, wherein the notification unit selects an appropriate notification method by considering the user's device information when notifying.
(Supplementary Note 23) The system according to Supplementary Note 1, wherein the notification unit selects an appropriate notification method by referring to the user's past notification history when notifying.

What is claimed is:

1. A system comprising:
circuitry configured to:
receive, via a packet-switched network from a client terminal, an audio signal captured by a transducer of the client terminal;
segment the audio signal into sequential frames and extract, from each frame, a feature vector to produce a feature vector sequence;
input the feature vector sequence into a speech recognition model having an encoder-decoder architecture, the encoder mapping the feature vector sequence to a latent representation and the decoder generating a text sequence using an alignment mechanism;
compute a confidence score for the generated text sequence;
in response to the confidence score exceeding a threshold, generate notification data comprising the text sequence; and
transmit the notification data to the client terminal via the packet-switched network, the notification data causing the client terminal to present the text sequence to a user.

2. The system according to claim 1, wherein the audio signal comprises an emergency broadcast signal, and wherein the circuitry is configured to receive the emergency broadcast signal in response to a single-touch operation on the client terminal.

3. The system according to claim 1, wherein the feature vector comprises a mel-frequency cepstral coefficient vector extracted from each frame of the audio signal.

4. The system according to claim 3, wherein the feature vector sequence comprises a multi-dimensional sequence including a base mel-frequency cepstral coefficient, a delta coefficient, and a delta-delta coefficient for each frame.

5. The system according to claim 1, wherein the alignment mechanism comprises at least one of a connectionist temporal classification mechanism or an attention mechanism.

6. The system according to claim 1, wherein the speech recognition model comprises a streaming speech recognition model configured to generate partial text sequences incrementally as sequential frames of the audio signal are received.

7. The system according to claim 1, wherein the circuitry is further configured to apply noise reduction to the audio signal prior to segmenting the audio signal, the noise reduction comprising at least one of spectral subtraction or Wiener filtering.

8. The system according to claim 1, wherein the circuitry is further configured to:
estimate an emotion of the user by applying an emotion identification model to sensor data received from the client terminal; and
adjust a parameter of the notification data based on the estimated emotion.

9. The system according to claim 8, wherein the sensor data comprises at least one of a facial image, an audio waveform, text input, or a biometric signal, and wherein the emotion identification model outputs an emotion label and an emotion intensity score.

10. The system according to claim 8, wherein adjusting the parameter of the notification data comprises adjusting at least one of a font size, a contrast ratio, a vibration pattern, or a display layout based on the estimated emotion.

11. The system according to claim 1, wherein the notification data further comprises a vibration control instruction that causes the client terminal to generate a vibration pattern, the vibration pattern being selected from continuous vibration and intermittent vibration based on an importance score associated with the audio signal.

12. The system according to claim 1, wherein the circuitry is further configured to:
acquire location data from the client terminal, the location data comprising at least one of latitude and longitude coordinates, a building identifier, or a floor number; and
filter incoming audio signals based on a geographic relevance score computed from the location data.

13. The system according to claim 1, wherein the circuitry is further configured to select a domain-specific vocabulary extension based on a category label associated with the audio signal, the category label identifying at least one of an earthquake, a fire, or a typhoon.

14. The system according to claim 1, wherein the circuitry is further configured to:
determine a source identifier associated with the audio signal; and
assign a recognition priority to the audio signal based on the source identifier, wherein a governmental source is assigned a higher recognition priority than a non-governmental source.

15. The system according to claim 1, wherein the circuitry is further configured to adjust a level of detail of the notification data based on an importance score associated with the audio signal, such that a higher importance score causes a more detailed notification and a lower importance score causes a more concise notification.

16. The system according to claim 1, wherein the circuitry is further configured to:
acquire device information from the client terminal, the device information comprising at least one of a device type, a screen resolution, or a battery level; and
select a notification method from among screen display, vibration, and audio output based on the device information.

17. The system according to claim 1, wherein the circuitry is further configured to:
maintain a notification history for the user, the notification history comprising past notification methods and user response data; and
select a notification method based on the notification history by applying a time-series analysis model to the user response data.

18. A system comprising:
a communication interface configured to communicate with a client terminal via a packet-switched network;
a memory storing a speech recognition model having an encoder-decoder architecture and an emotion identification model;
a database; and
circuitry configured to:
receive, from the client terminal via the communication interface, an audio signal captured by a microphone of the client terminal;
apply noise reduction to the audio signal;
segment the noise-reduced audio signal into sequential frames and extract, from each frame, a mel-frequency cepstral coefficient vector to produce a feature vector sequence;
input the feature vector sequence into the speech recognition model, the encoder mapping the feature vector sequence to a latent representation and the decoder generating a text sequence using at least one of a connectionist temporal classification mechanism or an attention mechanism;
compute a confidence score for the generated text sequence;
estimate an emotion of a user by applying the emotion identification model to sensor data received from the client terminal;
in response to the confidence score exceeding a threshold, generate notification data comprising the text sequence, the notification data having a display format adjusted based on the estimated emotion; and
transmit the notification data to the client terminal via the communication interface and the packet-switched network, the notification data causing the client terminal to present the text sequence on a display and to generate a vibration.

19. The system according to claim 18, wherein the circuitry is further configured to store, in the database, a notification history comprising the notification data and user response data associated with the notification data, and wherein the circuitry selects the display format based on the notification history.

20. A method performed by a system comprising circuitry, the method comprising:
receiving, via a packet-switched network from a client terminal, an audio signal captured by a transducer of the client terminal;
segmenting the audio signal into sequential frames and extracting, from each frame, a feature vector to produce a feature vector sequence;
inputting the feature vector sequence into a speech recognition model having an encoder-decoder architecture, the encoder mapping the feature vector sequence to a latent representation and the decoder generating a text sequence using an alignment mechanism;
computing a confidence score for the generated text sequence;
in response to the confidence score exceeding a threshold, generating notification data comprising the text sequence; and
transmitting the notification data to the client terminal via the packet-switched network, the notification data causing the client terminal to present the text sequence to a user.
